(19) United States
(12) Patent Application Publication
(10) Pub. No.: US 2026/0125527 A1
(43) Pub. Date: May 7, 2026

(54) MODIFIED ARAMID DOPE, AND PREPARATION METHOD AND USE THEREOF

(71) Applicants: YANTAI TAYHO ADVANCED MATERIALS RESEARCH INSTITUTE CO.,LTD, Yantai (CN); TAYHO ADVANCED MATERIALS GROUP CO., LTD., Yantai (CN)

(72) Inventors: Zhenhong GUAN, Yantai (CN); Dan LI, Yantai (CN); Ming JIANG, Yantai (CN); Fangbing LIN, Yantai (CN); Kuncheng YAO, Yantai (CN)

(73) Assignees: YANTAI TAYHO ADVANCED MATERIALS RESEARCH INSTITUTE CO.,LTD, Yantai (CN); TAYHO ADVANCED MATERIALS GROUP CO., LTD., Yantai (CN)

(21) Appl. No.: 19/437,648

(22) Filed: Dec. 31, 2025

Related U.S. Application Data
(63) Continuation of application No. PCT/CN2024/074572, filed on Jan. 30, 2024.

(30) Foreign Application Priority Data
Dec. 8, 2023 (CN) 202311677247.2

(51) Int. Cl. C08J 5/18; B32B 29/00; B32B 37/00; C08F 122/38; C08J 3/24; C08K 5/02; C08K 5/29

(52) U.S. Cl. CPC C08J 5/18; B32B 29/002; B32B 37/00; C08F 122/38; C08J 3/243; C08K 5/02; C08K 5/29; B32B 2037/0092; B32B 2250/02; B32B 2307/204; B32B 2307/206; B32B 2307/306; B32B 2307/54; B32B 2377/00; C08J 2335/00; C08J 2465/00

(57) ABSTRACT

Based on an aramid polymer prepared, the modified aramid dope is prepared through a combination of covalent crosslinking and non-covalent crosslinking. By adjusting the amounts of a crosslinking agent and a polar polymer, an aramid film is obtained that meets the following requirements simultaneously: superior heat resistance and mechanical strength, high toughness, a simple preparation process, high stretchability, and resistance to breakage. Furthermore, the aramid film can be directly laminated with aramid paper without use of an adhesive, so that a flexible composite material in compliance with insulation class F or H is prepared through direct lamination. This application is widely applicable to motors, generators, transformers, adhesive tape, and other fields.

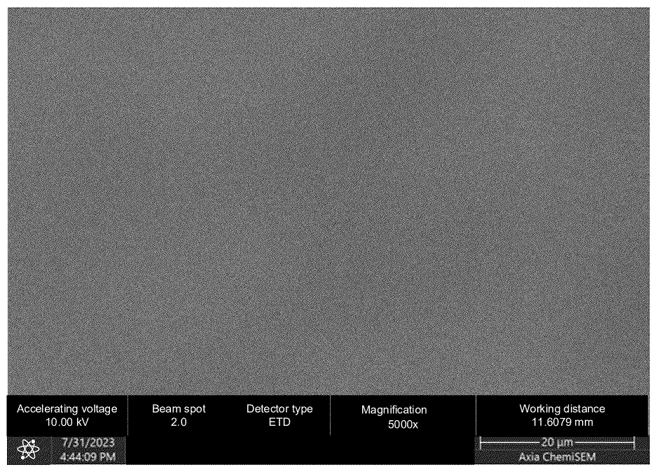

### CROSS-REFERENCE TO RELATED APPLICATIONS

This application is a continuation of International Application No. PCT/CN2024/074572, filed on Jan. 30, 2024, which claims priority to Chinese Patent Application No. 202311677247.2, filed on Dec. 8, 2023. The disclosures of the above-mentioned applications are hereby incorporated by reference in their entireties.

### TECHNICAL FIELD

This application relates to the field of aramid dope materials, and in particular, to a modified aramid dope, and a preparation method and a use thereof.

### BACKGROUND

Electrical-grade insulation films are commonly used in high-end insulation systems such as variable-frequency motors and generators due to properties such as corona resistance and high insulativity, and are mainly applied in the fields such as high-speed rail transportation, wind power generation, and new-energy vehicles. Currently, there are numerous types of electrical-grade insulation film materials, such as polyester film, polypropylene film, polycarbonate film, polyethylene, and polyimide film. Especially, the polyimide (PI) film, known for its high-temperature resistance, has been widely used in the electrical-grade insulation field. However, such materials suffer from problems such as high cost and poor hydrolysis resistance. The steady growth of the high-speed rail, wind power generation, and new-energy vehicle markets effectively impels the market size of the electrical-grade insulation films to keep expanding. Meanwhile, the performance requirements on devices are increasingly stringent, and people expect a wider range of high-temperature-resistant, high-strength, highly insulating, and oil-resistant film materials to be available for selection, so as to reduce production cost and broaden application ranges.

Aramid, also known as poly(p-phenylene terephthalamide), is a rigid macromolecule formed of amide groups and phenyl groups connected and arranged in an orderly structure. Strong hydrogen bonding and high degree of aromaticity in the molecular chain of aramid endow the aramid with excellent overall properties, such as excellent high-temperature resistance, flame retardance, high dimensional stability, insulativity, radiation resistance, acid- and alkali-resistance, high strength, and high modulus. Aramid is widely used in the fields such as tire-rubber reinforcement, high-temperature filtration, optical fiber reinforcement, protective clothing, transformer insulation materials, and honeycomb structure materials. Currently, aramid is mainly used in the fields of heat insulation, high-temperature resistance, and electrical insulation in the form of fibers and aramid paper. The aramid paper is heat-resistant to a degree of up to Thermal Class C (220° C.) and exhibits a relatively low dielectric constant. Aramid materials have become indispensable in the field of high-temperature-resistant insulation. Aramid films are characterized by high-temperature resistance, dimensional stability, a low dielectric constant, corrosion resistance, and the like. Compared with conventional PI films, aramid films exhibit excellent mechanical strength and hydrolysis resistance after being made into films, and can be produced at a low cost, thereby offering significant application potential. However, the large number of rigid phenyl groups and strong hydrogen bonding of the aramid films result in insufficient toughness of the aramid films, thereby imposing stringent requirements on the process parameters during film formation, and severely affecting the processability and applicability of the aramid films. For example, CN105384954B discloses a method for preparing an aramid insulation film using a poly(m-phenylene isophthalamide) resin. This method for preparing an aramid insulation film is to tape-cast a poly(m-phenylene isophthalamide) resin onto a flat glass template, spread the resin evenly using a doctor blade, and then perform thermal curing and heat treatment, where the poly(m-phenylene isophthalamide) resin is formed by a system of poly(isophthaloyl toluenediamine) dissolved in a dimethylacetamide-calcium chloride salt solution. As shown in an aging test, the elongation-at-break of the disclosed aramid insulation film varies at a change rate of R %. The change rate is at most 2.10%, indicating excessively low toughness and posing great difficulty to subsequent processing.

A commonly used method for toughening a polymer is to introduce a flexible chain segment such as an alkyl chain or an ether linkage. However, this reduces the heat resistance of the polymer to some extent and affects the mechanical strength of the polymer.

Another method for toughening a polymer is to add a toughening agent to improve the flexibility of the polymer. However, conventional methods often fail to achieve uniform dispersion of the toughening agent, thereby resulting in unstable mechanical strength or even an agglomeration-induced strength decline. For example, Chinese Application Publication CN116769306A discloses a modified meta-aramid film and a preparation method thereof, and an insulation paper and a preparation method thereof. The method for preparing the modified meta-aramid film is to mix a meta-aramid polymer solution with a high-temperature-resistant resin solution uniformly and then obtain the modified meta-aramid film using a film-forming method that employs a film material. The toughening agent used is any one or more of hyperbranched epoxy resin, hyperbranched polyester, hyperbranched unsaturated resin, or flexible benzoxazine. However, in this technical solution, the elongation-at-break of the ultimately prepared insulation paper is at most 15.51%, indicating relatively low toughness and posing great difficulty to subsequent processing.

In addition, polymer toughening methods that employ covalent crosslinking are also reported, but such crosslinked structures are very prone to form gelled polymers, making it impracticable to prepare films by means of solution processing. For aramid, it is crucial to achieve a trade-off between a plurality of performance metrics of the aramid film through rational design.

In view of the above situation in the prior art, there are still pressing technical challenges in the prior art: the aramid films still fail to meet the high-toughness requirement while meeting the requirements of superior heat resistance and mechanical strength, the preparation process is complicated, the aramid films are hardly stretchable and are prone to breakage, and the like.

### SUMMARY

To address the above technical challenges, this application provides a modified aramid dope. The modified aramid dope is obtained by covalently and non-covalently crosslinking an aramid polymer. The modified aramid dope contains a polymer represented by Structural Formula 1:

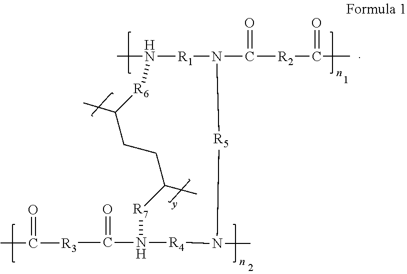

In the formula above, 100≤n₁≤200; 100≤n₂≤200; y is a number-average molecular weight that ranges from 2000 to 4000.

R₁, R₂, R₃, and R₄ each independently are one of

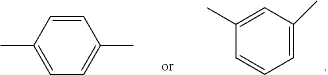

R₅ is one of

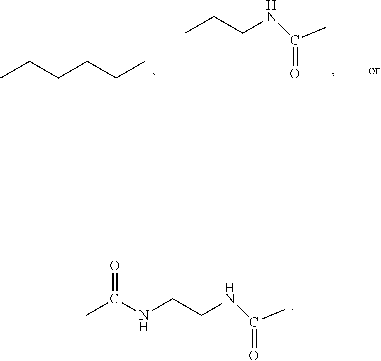

R₆ and R₇ each independently are one of —COOH, —CONH₂, or —OH.

In Formula 1, “ [symbol] ” represents one of hydrogen bonding or dipole interaction in non-covalent crosslinking.

In Formula 1, “ [symbol] ” represents one of hydrogen bonding or dipole interaction in non-covalent crosslinking.

The mass percent of the polymer in the modified aramid dope is 7% to 30%, and the remainder is a solvent.

The aramid polymer is derived from a polymerization reaction between phthaloyl chloride and phenylenediamine.

Further, the solvent is one of N,N-dimethylformamide (DMF), N,N-dimethylacetamide (DMAc), dimethyl sulfoxide (DMSO), or N-methylpyrrolidone (NMP).

Further, the phthaloyl chloride is one of isophthaloyl chloride or terephthaloyl chloride.

Further, the phenylenediamine is one of m-phenylenediamine or p-phenylenediamine.

This application further provides a method for preparing the modified aramid dope, including the following steps.

Step 1: preparing an aramid polymer dope: performing a polymerization reaction between phthaloyl chloride and phenylenediamine in an organic solvent under polymerization conditions to obtain a mixed polymer solution; adding a neutralization agent after completion of the reaction to neutralize an inorganic acid in the mixed polymer solution; and performing filtration to obtain the aramid polymer dope.

The mass concentration of the aramid polymer in the aramid polymer dope is 5% to 20%, a molar concentration of an aramid amide bond is 0.02 to 0.08 mol/g, a viscosity of the aramid polymer dope is 100 to 700 Pa·s, a molecular weight distribution is Mw/Mn=1.1 to 1.6, and a pH value of the aramid polymer dope is 7 to 8.

Step 2: preparing a covalently crosslinked aramid dope: adding an organic base into the aramid polymer dope in step 1 to perform deprotonation to remove hydrogen atoms attached to nitrogen atoms on an aramid amide bond and on an amino group in an original aramid polymer chain and to make the nitrogen atoms become negatively charged active sites; and then adding a crosslinking agent to perform a covalent crosslinking reaction so that the nitrogen atoms on the aramid amide bond and on the amino group in the original aramid polymer chain undergo bonding reactions with both ends of the crosslinking agent to form a covalent bond between adjacent molecular chains and obtain the covalently crosslinked aramid dope.

The viscosity of the covalently crosslinked aramid dope is 210 to 750 Pa·s, and a pH value of the covalently crosslinked aramid dope is 7.5 to 8.5.

Step 3: preparing a modified aramid dope: adding a polar polymer into the covalently crosslinked aramid dope prepared in step 2, and stirring to form non-covalent crosslinks while protonating, so as to obtain the modified aramid dope.

The viscosity of the modified aramid dope is 240 to 800 Pa·s, and a pH value of the modified aramid dope is 7.0 to 7.5.

Amide bonds that undergo covalent crosslinking and non-covalent crosslinking account for 5% to 20% of a total mass of amide bonds in the aramid polymer.

Further, the polymerization in step 1 is performed under a condition of stirring in an inert gas atmosphere at a temperature ranging from 5° C. to 55° C.

Further, the stirring speed is 500 r/min.

Further, the inert gas is nitrogen.

Further, the pressure of the inert gas is 0.03 MPa.

Further, a molar ratio of the phthaloyl chloride to the phenylenediamine in step 1 is 1.02:1.

Further, a mass concentration of the phenylenediamine dissolved in the solvent in step 1 is 2.5% to 10.5%.

Further, the organic solvent in step 1 is one of N,N-dimethylformamide (DMF), N,N-dimethylacetamide (DMAc), dimethyl sulfoxide (DMSO), or N-methylpyrrolidone (NMP).

Further, the reaction time of the polymerization reaction is 45 minutes.

Further, the polymerization reaction is divided into a first polymerization step and a second polymerization step. Before the polymerization reaction, the phthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The time ratio of the first aggregation step to the second aggregation step is 2:1.

The first polymerization step produces oligomers, and the oligomers undergo the second polymerization step to produce a polymer, so as to increase the molecular weight of the aramid polymer, reduce the molecular weight distribution, and improve the mechanical properties.

Further, the neutralization agent in step 1 is one of calcium oxide, calcium hydroxide, or ammonia, and is intended to neutralize the hydrogen chloride generated in the polymerization reaction. During the neutralization, a corresponding inorganic salt is generated. The inorganic salt is one of calcium chloride, sodium chloride, or ammonium chloride. The inorganic salt is filtered out from the mixed polymer solution by filtration.

Further, the amount of organic base added in step 2 is 5% to 20% of the molar mass of the aramid amide bond in the aramid polymer dope.

Further, before the organic base is added to the aramid polymer dope, the organic base is dissolved in a first solvent to obtain an organic base solution. The mass concentration of the organic base in the organic base solution is 30%.

Further, the first solvent is one of N,N-dimethylformamide (DMF), N,N-dimethylacetamide (DMAc), dimethyl sulfoxide (DMSO), or N-methylpyrrolidone (NMP).

Further, the organic base in step 2 is one of diethylamine, pyridine, or triethylamine.

Further, the deprotonation in step 2 is performed for a duration of 1 hour at a room temperature.

Further, the crosslinking agent in step 2 is an alkane containing a halogen element or an isocyanate group.

Further, the crosslinking agent is represented by Structural Formula 2:

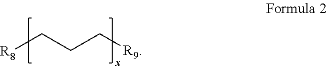

In the formula above, x is 1, 2, or 3.

R₈ is one of —Br, —Cl, or —N═C═O.

R₉ is one of —Br, —Cl, or —N═C═O.

Further, the amount of crosslinking agent added in step 2 is 2% to 10% of the molar mass of the aramid amide bond in the aramid polymer dope.

Further, the covalent crosslinking reaction in step 2 is performed for a duration of 10 minutes at a room temperature.

Further, the deprotonation in step 2 is: using an organic base to remove hydrogen atoms attached to nitrogen atoms on an aramid amide bond and on an amino group in the aramid polymer and to make the nitrogen atoms become negatively charged active sites, so as to undergo bonding reactions with both ends of the crosslinking agent to form a covalent bond.

Further, the polar polymer in step 3 is an alkyl-chain polymer.

Further, functional groups in the alkyl-chain polymer include one or more of a carboxyl group, an amino group, or a hydroxyl group.

Further, the alkyl-chain polymer contains a structural unit represented by Formula 3:

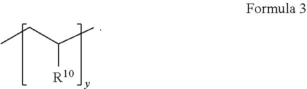

In the formula above, y represents a number-average molecular weight that ranges from 2000 to 4000.

R₁₀ is one of —COOH, —CONH₂, or —OH.

Further, the amount of the polar polymer added is 3% to 10% of the molar mass of the aramid amide bond in the aramid polymer dope.

Further, before the polar polymer is added to the covalently crosslinked aramid dope, the polar polymer is dissolved in a second solvent to obtain a polar polymer solution. The mass concentration of the polar polymer in the polar polymer solution is 30%.

Further, the second solvent is one of N,N-dimethylformamide (DMF), N,N-dimethylacetamide (DMAc), dimethyl sulfoxide (DMSO), or N-methylpyrrolidone (NMP).

Further, in step 3, the stirring is performed at a speed of 700 to 1000 r/min at a room temperature for a duration of 30 minutes.

Further, the protonation in step 3 is: using hydrogen atoms from the polar polymer to protonate the negatively charged nitrogen atoms on the aramid amide bond and the amino group in the aramid polymer, so as to undergo non-covalently crosslinking with the polar polymer through hydrogen bonding or dipole interaction.

This application further provides an aramid film. The aramid film is prepared by a biaxial stretching process from the above modified aramid dope. A thickness of the aramid film is 120.0 μm to 200.1 μm. A tensile strength of the aramid film is greater than or equal to 150.2 MPa. An elongation-at-break of the aramid film is greater than or equal to 80.1%. A heat resistance of the aramid film is greater than or equal to 410° C. Dielectric strength of the aramid film is greater than or equal to 150.8 kV/mm. Hygroscopicity of the aramid film is less than or equal to 3.9%.

Further, a method for preparing the aramid film includes the following steps:
Step 1: Tape-casting the modified aramid dope to form a thin film to obtain a cast film, washing the cast film with water, and drying the case film to obtain a preform film; and
Step 2: Performing biaxial stretching and thermal setting on the preform film in two mutually perpendicular directions simultaneously to obtain the aramid film.

Further, in step 1, the tape-casting is performed at a temperature of 100° C. to 200° C. for a duration of 5 to 20 minutes, and the precision of the tape-casting temperature is controlled to be 1° C.

Further, in step 1, the water washing is performed at a temperature of 15° C. to 45° C. for a duration of 5 to 180 seconds.

Further, in step 1, the drying temperature is 90° C. to 150° C. for a duration of 5 to 30 minutes.

Further, the mass percent of a solvent in the preform film in step 1 is 0.5% to 1.5%.

Further, the two mutually perpendicular directions are transverse direction (TD) and machine direction (MD) of the preform film.

Further, in step 2, the biaxial stretching is performed at a temperature of 130° C. to 250° C., the precision of the biaxial stretching temperature is controlled to be 1° C., and the stretch ratio of the biaxial stretching is 1.1 to 2.5.

Further, in step 2, the thermal setting is performed at a temperature of 250° C. to 300° C., and the precision of the thermal setting temperature is controlled to be ±1° C.

This application further provides a use of the aramid film. The aramid film is applicable to any one of the technical fields of motors, generators, transformers, or adhesive tape.

Further, the aramid film is directly laminated with aramid paper to prepare a composite material. An insulation class of the composite material is class F or class H, without a need for using an adhesive, thereby reducing cost while ensuring the structural stability and superior performance of the composite material.

Beneficial effects of the present invention are as follows.

Firstly, based on the prepared aramid polymer, this application prepares the modified aramid dope by means of covalent crosslinking in combination with non-covalent crosslinking.

Secondly, this application uses an organic base to deprotonate the aramid polymer dope, and then performs covalent crosslinking by adjusting the amount of the crosslinking agent, thereby disrupting the intermolecular force between some of the aramid polymer chains and forming a small amount of crosslinked aramid structures, and increasing the elongation-at-break of the aramid film to be prepared subsequently. At the same time, the covalent crosslinking can absorb more fracture energy without affecting the strength, and more efficiently transmit and disperse external forces to deplete and disperse the energy of external forces, thereby improving the mechanical strength and toughness of the aramid film.

Thirdly, the non-covalent crosslinking in this application is intended for the following purpose: by adjusting the amount of the polar polymer, the polar polymer forms non-covalent crosslinks with the deprotonated negatively-charged nitrogen atoms through hydrogen bonding or dipole interaction, thereby disrupting the regularity of the aramid polymer chains, increasing the movement space of the molecular chains, slowing down the crystallization behavior of the aramid polymer in the modified aramid dope, improving the toughness of the aramid film prepared from the modified aramid dope, avoiding gelling, and ensuring the smooth progress of the film coating process.

Fourthly, in this application, the prepared modified aramid dope is tape-cast and then washed and dried to ensure a specified solvent content in the preform film and ensure high shaping capability and stretchability of the preform film. After entry to the biaxial stretching process, the limitations caused by the crystallization behavior of the polymer, the viscosity, and the solvent in the modified aramid dope are overcome by combining a plurality of crosslinking types, thereby allowing the crystallinity and orientation index of the molecules in the aramid film to reach a balanced state, improving the toughness of the aramid film significantly while ensuring excellent mechanical strength of the aramid film, and solving the problems of low stretchability, complicated processing, and vulnerability-to-breakage of the aramid film.

Lastly, the aramid film preparation method provided in this application maintains the molecular structure integrity of the polymer, thereby keeping the inherent characteristics of aramid such as high strength and high modulus, inherent flame retardancy, high-temperature resistance, and a low dielectric constant. The aramid film can be directly laminated with aramid paper to prepare a class-F or class-H flexible composite material without the use of an adhesive, and can be applied in fields such as motors, generators, transformers, and adhesive tape. The direct lamination is based on the principles that the aramid film and the aramid paper can form reciprocally stable hydrogen bonds due to homogeneity and homology, thereby improving the strength of the composite material.

### BRIEF DESCRIPTION OF THE DRAWINGS

The accompanied FIGURE is an SEM image of a surface of an aramid film prepared in Embodiment 22 of this application.

### DETAILED DESCRIPTION OF THE EMBODIMENTS

### Embodiment 1

This embodiment provides a method for preparing a modified aramid dope, including the following steps.

Step 1: preparing an aramid polymer dope: performing a polymerization reaction between phthaloyl chloride and phenylenediamine at a molar ratio of 1.02:1 in an organic solvent under polymerization conditions, and specifically, dissolving 400 mol of m-phenylenediamine in an organic solvent N,N-dimethylacetamide (DMAc) to formulate an m-phenylenediamine solution at a mass percent of 10.5%, and then adding 408 mol of isophthaloyl chloride to initiate a polymerization reaction to obtain a mixed polymer solution.

The polymerization reaction is divided into a first polymerization step and a second polymerization step.

Specifically, before the polymerization reaction, 408 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, calcium oxide is added as a neutralization agent to neutralize the inorganic acid in the mixed polymer solution, and then the mixture is filtered to obtain the aramid polymer dope.

The mass concentration of the aramid polymer in the aramid polymer dope is 20%. The molar concentration of the aramid amide bond is 0.08 mol/g. The viscosity of the aramid polymer dope is 600 Pa·s. The molecular weight distribution is Mw/Mn=1.3. The pH value of the aramid polymer dope is 7.

Step 2: preparing a covalently crosslinked aramid dope: adding diethylamine as an organic base into the aramid polymer dope in step 1 to perform deprotonation, and stirring for 1 hour, where the concentration of the diethylamine is 10% of the molar mass of the aramid amide bond; and then adding 1,6-dibromohexane as a crosslinking agent to perform a covalent crosslinking reaction, where the concentration of the 1,6-dibromohexane is 5% of the molar mass of the aramid amide; and performing a covalent crosslinking reaction at a room temperature for 10 minutes to obtain the covalently crosslinked aramid dope.

Before the organic base is added to the aramid polymer dope, the organic base is dissolved in a first solvent, that is, N,N-dimethylacetamide (DMAc), to obtain an organic base solution. The mass concentration of the organic base in the organic base solution is 30%.

The viscosity of the covalently crosslinked aramid dope is 670 Pa·s. The pH value of the covalently crosslinked aramid dope is 7.8.

Step 3: preparing a modified aramid dope: Adding a polar polymer into the covalently crosslinked aramid dope prepared in step 2, and stirring the mixture at a room temperature at a speed of 850 r/min for a duration of 30 minutes. In this embodiment, the polar polymer is polyacrylamide (PAM) with a number-average molecular weight (y) of 2000. The concentration of the polyacrylamide is 5% of the molar mass of the aramid amide bond. In this way, non-covalent crosslinks are formed during protonation, so as to obtain the modified aramid dope.

In the above process, before the polar polymer is added to the covalently crosslinked aramid dope, the polar polymer is dissolved in a second solvent, that is, N,N-dimethylacetamide (DMAc), to obtain a polar polymer solution. The mass concentration of the polar polymer in the polar polymer solution is 30%.

The viscosity of the modified aramid dope is 700 Pa·s. The pH value of the modified aramid dope is 7.3.

In this embodiment, the amide bonds that undergo covalent crosslinking and non-covalent crosslinking account for 10% of the total mass of the amide bonds in the aramid polymer.

### Embodiment 2

This embodiment provides a method for preparing a modified aramid dope, including the following steps.

Step 1: preparing an aramid polymer dope: performing a polymerization reaction between phthaloyl chloride and phenylenediamine at a molar ratio of 1.02:1 in an organic solvent under polymerization conditions, and specifically, dissolving 300 mol of m-phenylenediamine in an organic solvent N,N-dimethylformamide (DMF) to formulate an m-phenylenediamine solution at a mass percent of 7.8%, and then adding 306 mol of isophthaloyl chloride to initiate a polymerization reaction to obtain a mixed polymer solution.

The polymerization reaction is divided into a first polymerization step and a second polymerization step.

Specifically, before the polymerization reaction, 306 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, calcium hydroxide is added as a neutralization agent to neutralize the inorganic acid in the mixed polymer solution, and then the mixture is filtered to obtain the aramid polymer dope.

The mass concentration of the aramid polymer in the aramid polymer dope is 15%. The molar concentration of the aramid amide bond is 0.06 mol/g. The viscosity of the aramid polymer dope is 500 Pa·s. The molecular weight distribution is Mw/Mn=1.5. The pH value of the aramid polymer dope is 7.5.

Step 2: preparing a covalently crosslinked aramid dope: adding diethylamine as an organic base into the aramid polymer dope in step 1 to perform deprotonation, and stirring for 1 hour, where the concentration of the diethylamine is 10% of the molar mass of the aramid amide bond; and then adding 1,6-dibromohexane as a crosslinking agent to perform a covalent crosslinking reaction, where the concentration of the 1,6-dibromohexane is 5% of the molar mass of the aramid amide; and performing a covalent crosslinking reaction at a room temperature for 10 minutes to obtain the covalently crosslinked aramid dope.

Before the organic base is added to the aramid polymer dope, the organic base is dissolved in a first solvent, that is, N,N-dimethylformamide (DMF), to obtain an organic base solution. The mass concentration of the organic base in the organic base solution is 30%.

The viscosity of the covalently crosslinked aramid dope is 590 Pa·s. The pH value of the covalently crosslinked aramid dope is 8.2.

Step 3: preparing a modified aramid dope: Adding a polar polymer into the covalently crosslinked aramid dope prepared in step 2, and stirring the mixture at a room temperature at a speed of 900 r/min for a duration of 30 minutes. In this embodiment, the polar polymer is polyacrylic acid (PAA) with a number-average molecular weight (y) of 4000. The concentration of the polyacrylic acid is 5% of the molar mass of the aramid amide bond. In this way, non-covalent crosslinks are formed during protonation, so as to obtain the modified aramid dope.

In the above process, before the polar polymer is added to the covalently crosslinked aramid dope, the polar polymer is dissolved in a second solvent, that is, N,N-dimethylformamide (DMF), to obtain a polar polymer solution. The mass concentration of the polar polymer in the polar polymer solution is 30%.

The viscosity of the modified aramid dope is 610 Pa·s. The pH value of the modified aramid dope is 7.2.

In this embodiment, the amide bonds that undergo covalent crosslinking and non-covalent crosslinking account for 10% of the total mass of the amide bonds in the aramid polymer.

### Embodiment 3

This embodiment provides a method for preparing a modified aramid dope, including the following steps.

Step 1: preparing an aramid polymer dope: performing a polymerization reaction between phthaloyl chloride and phenylenediamine at a molar ratio of 1.02:1 in an organic solvent under polymerization conditions, and specifically, dissolving 300 mol of m-phenylenediamine in an organic solvent dimethyl sulfoxide (DMSO) to formulate an m-phenylenediamine solution at a mass percent of 7.8%, and then adding 306 mol of isophthaloyl chloride to initiate a polymerization reaction to obtain a mixed polymer solution.

The polymerization reaction is divided into a first polymerization step and a second polymerization step.

Specifically, before the polymerization reaction, 306 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, ammonia is added as a neutralization agent to neutralize the inorganic acid in the mixed polymer solution, and then the mixture is filtered to obtain the aramid polymer dope.

The mass concentration of the aramid polymer in the aramid polymer dope is 15%. The molar concentration of the aramid amide bond is 0.06 mol/g. The viscosity of the aramid polymer dope is 540 Pa·s. The molecular weight distribution is Mw/Mn=1.6. The pH value of the aramid polymer dope is 7.2.

Step 2: preparing a covalently crosslinked aramid dope: adding triethylamine as an organic base into the aramid polymer dope in step 1 to perform deprotonation, and stirring for 1 hour, where the concentration of the triethylamine is 10% of the molar mass of the aramid amide bond; and then adding 1,6-dibromohexane as a crosslinking agent to perform a covalent crosslinking reaction, where the concentration of the 1,6-dibromohexane is 5% of the molar mass of the aramid amide; and performing a covalent crosslinking reaction at a room temperature for 10 minutes to obtain the covalently crosslinked aramid dope.

Before the organic base is added to the aramid polymer dope, the organic base is dissolved in a first solvent, that is, dimethyl sulfoxide (DMSO), to obtain an organic base solution. The mass concentration of the organic base in the organic base solution is 30%.

The viscosity of the covalently crosslinked aramid dope is 600 Pa·s. The pH value of the covalently crosslinked aramid dope is 7.6.

Step 3: preparing a modified aramid dope: Adding a polar polymer into the covalently crosslinked aramid dope prepared in step 2, and stirring the mixture at a room temperature at a speed of 750 r/min for a duration of 30 minutes. In this embodiment, the polar polymer is polyvinyl alcohol (PVA) with a number-average molecular weight (y) of 2000. The concentration of the polyvinyl alcohol is 5% of the molar mass of the aramid amide bond. In this way, non-covalent crosslinks are formed during protonation, so as to obtain the modified aramid dope.

In the above process, before the polar polymer is added to the covalently crosslinked aramid dope, the polar polymer is dissolved in a second solvent, that is, dimethyl sulfoxide (DMSO), to obtain a polar polymer solution. The mass concentration of the polar polymer in the polar polymer solution is 30%.

The viscosity of the modified aramid dope is 630 Pa·s. The pH value of the modified aramid dope is 7.1.

In this embodiment, the amide bonds that undergo covalent crosslinking and non-covalent crosslinking account for 10% of the total mass of the amide bonds in the aramid polymer.

### Embodiment 4

This embodiment provides a method for preparing a modified aramid dope, including the following steps.

Step 1: preparing an aramid polymer dope: performing a polymerization reaction between phthaloyl chloride and phenylenediamine at a molar ratio of 1.02:1 in an organic solvent under polymerization conditions, and specifically, dissolving 300 mol of m-phenylenediamine in an organic solvent N-methylpyrrolidone (NMP) to formulate an m-phenylenediamine solution at a mass percent of 7.8%, and then adding 306 mol of isophthaloyl chloride to initiate a polymerization reaction to obtain a mixed polymer solution.

The polymerization reaction is divided into a first polymerization step and a second polymerization step.

Specifically, before the polymerization reaction, 306 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, calcium hydroxide is added as a neutralization agent to neutralize the inorganic acid in the mixed polymer solution, and then the mixture is filtered to obtain the aramid polymer dope.

The mass concentration of the aramid polymer in the aramid polymer dope is 15%. The molar concentration of the aramid amide bond is 0.06 mol/g. The viscosity of the aramid polymer dope is 600 Pa·s. The molecular weight distribution is Mw/Mn=1.2. The pH value of the aramid polymer dope is 7.3.

Step 2: preparing a covalently crosslinked aramid dope: adding pyridine as an organic base into the aramid polymer dope in step 1 to perform deprotonation, and stirring for 1 hour, where the concentration of the pyridine is 10% of the molar mass of the aramid amide bond; and then adding 1,4-dichlorobutane as a crosslinking agent to perform a covalent crosslinking reaction, where the concentration of the 1,4-dichlorobutane is 5% of the molar mass of the aramid amide; and performing a covalent crosslinking reaction at a room temperature for 10 minutes to obtain the covalently crosslinked aramid dope.

Before the organic base is added to the aramid polymer dope, the organic base is dissolved in a first solvent, that is, N-methylpyrrolidone (NMP), to obtain an organic base solution. The mass concentration of the organic base in the organic base solution is 30%.

The viscosity of the covalently crosslinked aramid dope is 660 Pa·s. The pH value of the covalently crosslinked aramid dope is 7.8.

Step 3: preparing a modified aramid dope: Adding a polar polymer into the covalently crosslinked aramid dope prepared in step 2, and stirring the mixture at a room temperature at a speed of 800 r/min for a duration of 30 minutes. In this embodiment, the polar polymer is polyacrylic acid (PAA) with a number-average molecular weight (y) of 2000. The concentration of the polyacrylic acid is 5% of the molar mass of the aramid amide bond. In this way, non-covalent crosslinks are formed during protonation, so as to obtain the modified aramid dope.

In the above process, before the polar polymer is added to the covalently crosslinked aramid dope, the polar polymer is dissolved in a second solvent, that is, N-methylpyrrolidone (NMP), to obtain a polar polymer solution. The mass concentration of the polar polymer in the polar polymer solution is 30%.

The viscosity of the modified aramid dope is 700 Pa·s. The pH value of the modified aramid dope is 7.0.

In this embodiment, the amide bonds that undergo covalent crosslinking and non-covalent crosslinking account for 10% of the total mass of the amide bonds in the aramid polymer.

### Embodiment 5

This embodiment provides a method for preparing a modified aramid dope, including the following steps.

Step 1: preparing an aramid polymer dope: performing a polymerization reaction between phthaloyl chloride and phenylenediamine at a molar ratio of 1.02:1 in an organic solvent under polymerization conditions, and specifically, dissolving 300 mol of m-phenylenediamine in an organic solvent N,N-dimethylacetamide (DMAc) to formulate an m-phenylenediamine solution at a mass percent of 7.8%, and then adding 306 mol of isophthaloyl chloride to initiate a polymerization reaction to obtain a mixed polymer solution.

The polymerization reaction is divided into a first polymerization step and a second polymerization step.

Specifically, before the polymerization reaction, 306 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, calcium oxide is added as a neutralization agent to neutralize the inorganic acid in the mixed polymer solution, and then the mixture is filtered to obtain the aramid polymer dope.

The mass concentration of the aramid polymer in the aramid polymer dope is 15%. The molar concentration of the aramid amide bond is 0.06 mol/g. The viscosity of the aramid polymer dope is 450 Pa·s. The molecular weight distribution is Mw/Mn=1.4. The pH value of the aramid polymer dope is 7.1.

Step 2: preparing a covalently crosslinked aramid dope: adding pyridine as an organic base into the aramid polymer dope in step 1 to perform deprotonation, and stirring for 1 hour, where the concentration of the pyridine is 10% of the molar mass of the aramid amide bond; and then adding 1,6-hexamethylene diisocyanate as a crosslinking agent to perform a covalent crosslinking reaction, where the concentration of the 1,6-hexamethylene diisocyanate is 5% of the molar mass of the aramid amide; and performing a covalent crosslinking reaction at a room temperature for 10 minutes to obtain the covalently crosslinked aramid dope.

Before the organic base is added to the aramid polymer dope, the organic base is dissolved in a first solvent, that is, N,N-dimethylacetamide (DMAc), to obtain an organic base solution. The mass concentration of the organic base in the organic base solution is 30%.

The viscosity of the covalently crosslinked aramid dope is 500 Pa·s. The pH value of the covalently crosslinked aramid dope is 7.5.

Step 3: preparing a modified aramid dope: Adding a polar polymer into the covalently crosslinked aramid dope prepared in step 2, and stirring the mixture at a room temperature at a speed of 900 r/min for a duration of 30 minutes. In this embodiment, the polar polymer is polyacrylic acid (PAA) with a number-average molecular weight (y) of 4000. The concentration of the polyacrylic acid is 5% of the molar mass of the aramid amide bond. In this way, non-covalent crosslinks are formed during protonation, so as to obtain the modified aramid dope.

In the above process, before the polar polymer is added to the covalently crosslinked aramid dope, the polar polymer is dissolved in a second solvent, that is, N,N-dimethylacetamide (DMAc), to obtain a polar polymer solution. The mass concentration of the polar polymer in the polar polymer solution is 30%.

The viscosity of the modified aramid dope is 530 Pa·s. The pH value of the modified aramid dope is 7.2.

In this embodiment, the amide bonds that undergo covalent crosslinking and non-covalent crosslinking account for 10% of the total mass of the amide bonds in the aramid polymer.

### Embodiment 6

This embodiment provides a method for preparing a modified aramid dope, including the following steps:

Step 1: preparing an aramid polymer dope: performing a polymerization reaction between phthaloyl chloride and phenylenediamine at a molar ratio of 1.02:1 in an organic solvent under polymerization conditions, and specifically, dissolving 400 mol of m-phenylenediamine in an organic solvent N,N-dimethylacetamide (DMAc) to formulate an m-phenylenediamine solution at a mass percent of 10.5%, and then adding 408 mol of isophthaloyl chloride to initiate a polymerization reaction to obtain a mixed polymer solution.

The polymerization reaction is divided into a first polymerization step and a second polymerization step.

Specifically, before the polymerization reaction, 408 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, calcium oxide is added as a neutralization agent to neutralize the inorganic acid in the mixed polymer solution, and then the mixture is filtered to obtain the aramid polymer dope.

The mass concentration of the aramid polymer in the aramid polymer dope is 20%. The molar concentration of the aramid amide bond is 0.08 mol/g. The viscosity of the aramid polymer dope is 700 Pa·s. The molecular weight distribution is Mw/Mn=1.5. The pH value of the aramid polymer dope is 7.3.

Step 2: preparing a covalently crosslinked aramid dope: adding diethylamine as an organic base into the aramid polymer dope in step 1 to perform deprotonation, and stirring for 1 hour, where the concentration of the diethylamine is 10% of the molar mass of the aramid amide bond; and then adding 1,6-dibromohexane as a crosslinking agent to perform a covalent crosslinking reaction, where the concentration of the 1,6-dibromohexane is 2% of the molar mass of the aramid amide; and performing a covalent crosslinking reaction at a room temperature for 10 minutes to obtain the covalently crosslinked aramid dope.

Before the organic base is added to the aramid polymer dope, the organic base is dissolved in a first solvent, that is, N,N-dimethylacetamide (DMAc), to obtain an organic base solution. The mass concentration of the organic base in the organic base solution is 30%.

The viscosity of the covalently crosslinked aramid dope is 760 Pa·s. The pH value of the covalently crosslinked aramid dope is 7.8.

Step 3: preparing a modified aramid dope: Adding a polar polymer into the covalently crosslinked aramid dope prepared in step 2, and stirring the mixture at a room temperature at a speed of 700 r/min for a duration of 30 minutes. In this embodiment, the polar polymer is polyacrylic acid (PAA) with a number-average molecular weight (y) of 2000. The concentration of the polyacrylic acid is 3% of the molar mass of the aramid amide bond. In this way, non-covalent crosslinks are formed during protonation, so as to obtain the modified aramid dope.

In the above process, before the polar polymer is added to the covalently crosslinked aramid dope, the polar polymer is dissolved in a second solvent, that is, N,N-dimethylacetamide (DMAc), to obtain a polar polymer solution. The mass concentration of the polar polymer in the polar polymer solution is 30%.

The viscosity of the modified aramid dope is 800 Pa·s. The pH value of the modified aramid dope is 7.1.

In this embodiment, the amide bonds that undergo covalent crosslinking and non-covalent crosslinking account for 5% of the total mass of the amide bonds in the aramid polymer.

### Embodiment 7

This embodiment provides a method for preparing a modified aramid dope, including the following steps.

Step 1: preparing an aramid polymer dope: performing a polymerization reaction between phthaloyl chloride and phenylenediamine at a molar ratio of 1.02:1 in an organic solvent under polymerization conditions, and specifically, dissolving 200 mol of m-phenylenediamine in an organic solvent N,N-dimethylacetamide (DMAc) to formulate an m-phenylenediamine solution at a mass percent of 5%, and then adding 204 mol of isophthaloyl chloride to initiate a polymerization reaction to obtain a mixed polymer solution.

The polymerization reaction is divided into a first polymerization step and a second polymerization step.

Specifically, before the polymerization reaction, 204 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, calcium hydroxide is added as a neutralization agent to neutralize the inorganic acid in the mixed polymer solution, and then the mixture is filtered to obtain the aramid polymer dope.

The mass concentration of the aramid polymer in the aramid polymer dope is 10%. The molar concentration of the aramid amide bond is 0.04 mol/g. The viscosity of the aramid polymer dope is 350 Pa·s. The molecular weight distribution is Mw/Mn=1.6. The pH value of the aramid polymer dope is 7.1.

Step 2: preparing a covalently crosslinked aramid dope: adding diethylamine as an organic base into the aramid polymer dope in step 1 to perform deprotonation, and stirring for 1 hour, where the concentration of the diethylamine is 15% of the molar mass of the aramid amide bond; and then adding 1,6-dibromohexane as a crosslinking agent to perform a covalent crosslinking reaction, where the concentration of the 1,6-dibromohexane is 5% of the molar mass of the aramid amide; and performing a covalent crosslinking reaction at a room temperature for 10 minutes to obtain the covalently crosslinked aramid dope.

Before the organic base is added to the aramid polymer dope, the organic base is dissolved in a first solvent, that is, N,N-dimethylacetamide (DMAc), to obtain an organic base solution. The mass concentration of the organic base in the organic base solution is 30%.

The viscosity of the covalently crosslinked aramid dope is 400 Pa·s. The pH value of the covalently crosslinked aramid dope is 8.0.

Step 3: preparing a modified aramid dope: Adding a polar polymer into the covalently crosslinked aramid dope prepared in step 2, and stirring the mixture at a room temperature at a speed of 950 r/min for a duration of 30 minutes. In this embodiment, the polar polymer is polyacrylic acid (PAA) with a number-average molecular weight (y) of 2000. The concentration of the polyacrylic acid is 10% of the molar mass of the aramid amide bond. In this way, non-covalent crosslinks are formed during protonation, so as to obtain the modified aramid dope.

In the above process, before the polar polymer is added to the covalently crosslinked aramid dope, the polar polymer is dissolved in a second solvent, that is, N,N-dimethylacetamide (DMAc), to obtain a polar polymer solution. The mass concentration of the polar polymer in the polar polymer solution is 30%.

The viscosity of the modified aramid dope is 425 Pa·s. The pH value of the modified aramid dope is 7.5.

In this embodiment, the amide bonds that undergo covalent crosslinking and non-covalent crosslinking account for 15% of the total mass of the amide bonds in the aramid polymer.

### Embodiment 8

This embodiment provides a method for preparing a modified aramid dope, including the following steps.

Step 1: preparing an aramid polymer dope: performing a polymerization reaction between phthaloyl chloride and phenylenediamine at a molar ratio of 1.02:1 in an organic solvent under polymerization conditions, and specifically, dissolving 200 mol of m-phenylenediamine in an organic solvent N,N-dimethylacetamide (DMAc) to formulate an m-phenylenediamine solution at a mass percent of 7.8%, and then adding 204 mol of isophthaloyl chloride to initiate a polymerization reaction to obtain a mixed polymer solution.

The polymerization reaction is divided into a first polymerization step and a second polymerization step.

Specifically, before the polymerization reaction, 204 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, calcium hydroxide is added as a neutralization agent to neutralize the inorganic acid in the mixed polymer solution, and then the mixture is filtered to obtain the aramid polymer dope.

The mass concentration of the aramid polymer in the aramid polymer dope is 15%. The molar concentration of the aramid amide bond is 0.06 mol/g. The viscosity of the aramid polymer dope is 500 Pa·s. The molecular weight distribution is Mw/Mn=1.1. The pH value of the aramid polymer dope is 7.3.

Step 2: preparing a covalently crosslinked aramid dope: adding diethylamine as an organic base into the aramid polymer dope in step 1 to perform deprotonation, and stirring for 1 hour, where the concentration of the diethylamine is 10% of the molar mass of the aramid amide bond; and then adding 1,6-dibromohexane as a crosslinking agent to perform a covalent crosslinking reaction, where the concentration of the 1,6-dibromohexane is 5% of the molar mass of the aramid amide; and performing a covalent crosslinking reaction at a room temperature for 10 minutes to obtain the covalently crosslinked aramid dope.

Before the organic base is added to the aramid polymer dope, the organic base is dissolved in a first solvent, that is, N,N-dimethylacetamide (DMAc), to obtain an organic base solution. The mass concentration of the organic base in the organic base solution is 30%.

The viscosity of the covalently crosslinked aramid dope is 670 Pa·s. The pH value of the covalently crosslinked aramid dope is 8.5.

Step 3: preparing a modified aramid dope: Adding a polar polymer into the covalently crosslinked aramid dope prepared in step 2, and stirring the mixture at a room temperature at a speed of 800 r/min for a duration of 30 minutes. In this embodiment, the polar polymer is polyacrylic acid (PAA) with a number-average molecular weight (y) of 2000. The concentration of the polyacrylic acid is 5% of the molar mass of the aramid amide bond. In this way, non-covalent crosslinks are formed during protonation, so as to obtain the modified aramid dope.

In the above process, before the polar polymer is added to the covalently crosslinked aramid dope, the polar polymer is dissolved in a second solvent, that is, N,N-dimethylacetamide (DMAc), to obtain a polar polymer solution. The mass concentration of the polar polymer in the polar polymer solution is 30%.

The viscosity of the modified aramid dope is 700 Pa·s. The pH value of the modified aramid dope is 7.2.

In this embodiment, the amide bonds that undergo covalent crosslinking and non-covalent crosslinking account for 10% of the total mass of the amide bonds in the aramid polymer.

### Embodiment 9

This embodiment provides a method for preparing a modified aramid dope, including the following steps.

Step 1: preparing an aramid polymer dope: performing a polymerization reaction between phthaloyl chloride and phenylenediamine at a molar ratio of 1.02:1 in an organic solvent under polymerization conditions, and specifically, dissolving 200 mol of m-phenylenediamine in an organic solvent N,N-dimethylacetamide (DMAc) to formulate an m-phenylenediamine solution at a mass percent of 7.8%, and then adding 204 mol of isophthaloyl chloride to initiate a polymerization reaction to obtain a mixed polymer solution.

The polymerization reaction is divided into a first polymerization step and a second polymerization step.

Specifically, before the polymerization reaction, 204 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, ammonia is added as a neutralization agent to neutralize the inorganic acid in the mixed polymer solution, and then the mixture is filtered to obtain the aramid polymer dope.

The mass concentration of the aramid polymer in the aramid polymer dope is 15%. The molar concentration of the aramid amide bond is 0.06 mol/g. The viscosity of the aramid polymer dope is 450 Pa·s. The molecular weight distribution is Mw/Mn=1.3. The pH value of the aramid polymer dope is 7.5.

Step 2: preparing a covalently crosslinked aramid dope: adding diethylamine as an organic base into the aramid polymer dope in step 1 to perform deprotonation, and stirring for 1 hour, where the concentration of the diethylamine is 15% of the molar mass of the aramid amide bond; and then adding 1,6-dibromohexane as a crosslinking agent to perform a covalent crosslinking reaction, where the concentration of the 1,6-dibromohexane is 7.5% of the molar mass of the aramid amide; and performing a covalent crosslinking reaction at a room temperature for 10 minutes to obtain the covalently crosslinked aramid dope.

Before the organic base is added to the aramid polymer dope, the organic base is dissolved in a first solvent, that is, N,N-dimethylacetamide (DMAc), to obtain an organic base solution. The mass concentration of the organic base in the organic base solution is 30%.

The viscosity of the covalently crosslinked aramid dope is 560 Pa·s. The pH value of the covalently crosslinked aramid dope is 8.3.

Step 3: preparing a modified aramid dope: Adding a polar polymer into the covalently crosslinked aramid dope prepared in step 2, and stirring the mixture at a room temperature at a speed of 850 r/min for a duration of 30 minutes. In this embodiment, the polar polymer is polyacrylic acid (PAA) with a number-average molecular weight (y) of 2000. The concentration of the polyacrylic acid is 7.5% of the molar mass of the aramid amide bond. In this way, non-covalent crosslinks are formed during protonation, so as to obtain the modified aramid dope.

In the above process, before the polar polymer is added to the covalently crosslinked aramid dope, the polar polymer is dissolved in a second solvent, that is, N,N-dimethylacetamide (DMAc), to obtain a polar polymer solution. The mass concentration of the polar polymer in the polar polymer solution is 30%.

The viscosity of the modified aramid dope is 600 Pa·s. The pH value of the modified aramid dope is 7.1.

In this embodiment, the amide bonds that undergo covalent crosslinking and non-covalent crosslinking account for 15% of the total mass of the amide bonds in the aramid polymer.

### Embodiment 10

This embodiment provides a method for preparing a modified aramid dope, including the following steps.

Step 1: preparing an aramid polymer dope: performing a polymerization reaction between phthaloyl chloride and phenylenediamine at a molar ratio of 1.02:1 in an organic solvent under polymerization conditions, and specifically, dissolving 100 mol of p-phenylenediamine in an organic solvent N,N-dimethylacetamide (DMAc) to formulate a p-phenylenediamine solution at a mass percent of 2.5%, and then adding 102 mol of terephthaloyl chloride to initiate a polymerization reaction to obtain a mixed polymer solution.

The polymerization reaction is divided into a first polymerization step and a second polymerization step.

Specifically, before the polymerization reaction, 102 mol of terephthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into a p-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, calcium hydroxide is added as a neutralization agent to neutralize the inorganic acid in the mixed polymer solution, and then the mixture is filtered to obtain the aramid polymer dope.

The mass concentration of the aramid polymer in the aramid polymer dope is 5%. The molar concentration of the aramid amide bond is 0.02 mol/g. The viscosity of the aramid polymer dope is 100 Pa·s. The molecular weight distribution is Mw/Mn=1.5. The pH value of the aramid polymer dope is 8.

Step 2: preparing a covalently crosslinked aramid dope: adding diethylamine as an organic base into the aramid polymer dope in step 1 to perform deprotonation, and stirring for 1 hour, where the concentration of the diethylamine is 20% of the molar mass of the aramid amide bond; and then adding 1,6-dibromohexane as a crosslinking agent to perform a covalent crosslinking reaction, where the concentration of the 1,6-dibromohexane is 10% of the molar mass of the aramid amide; and performing a covalent crosslinking reaction at a room temperature for 10 minutes to obtain the covalently crosslinked aramid dope.

Before the organic base is added to the aramid polymer dope, the organic base is dissolved in a first solvent, that is, N,N-dimethylacetamide (DMAc), to obtain an organic base solution. The mass concentration of the organic base in the organic base solution is 30%.

The viscosity of the covalently crosslinked aramid dope is 210 Pa·s. The pH value of the covalently crosslinked aramid dope is 8.5.

Step 3: preparing a modified aramid dope: Adding a polar polymer into the covalently crosslinked aramid dope prepared in step 2, and stirring the mixture at a room temperature at a speed of 1000 r/min for a duration of 30 minutes. In this embodiment, the polar polymer is polyacrylic acid (PAA) with a number-average molecular weight (y) of 2000. The concentration of the polyacrylic acid is 10% of the molar mass of the aramid amide bond. In this way, non-covalent crosslinks are formed during protonation, so as to obtain the modified aramid dope.

In the above process, before the polar polymer is added to the covalently crosslinked aramid dope, the polar polymer is dissolved in a second solvent, that is, N,N-dimethylacetamide (DMAc), to obtain a polar polymer solution. The mass concentration of the polar polymer in the polar polymer solution is 30%.

The viscosity of the modified aramid dope is 240 Pa·s. The pH value of the modified aramid dope is 7.4.

In this embodiment, the amide bonds that undergo covalent crosslinking and non-covalent crosslinking account for 20% of the total mass of the amide bonds in the aramid polymer.

### Embodiment 11

This embodiment provides a method for preparing a modified aramid dope, including the following steps.

Step 1: preparing an aramid polymer dope: performing a polymerization reaction between phthaloyl chloride and phenylenediamine at a molar ratio of 1.02:1 in an organic solvent under polymerization conditions, and specifically, dissolving 300 mol of m-phenylenediamine in an organic solvent N,N-dimethylacetamide (DMAc) to formulate an m-phenylenediamine solution at a mass percent of 7.8%, and then adding 306 mol of isophthaloyl chloride to initiate a polymerization reaction to obtain a mixed polymer solution.

The polymerization reaction is divided into a first polymerization step and a second polymerization step.

Specifically, before the polymerization reaction, 306 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, ammonia is added as a neutralization agent to neutralize the inorganic acid in the mixed polymer solution, and then the mixture is filtered to obtain the aramid polymer dope.

The mass concentration of the aramid polymer in the aramid polymer dope is 15%. The molar concentration of the aramid amide bond is 0.06 mol/g. The viscosity of the aramid polymer dope is 500 Pa·s. The molecular weight distribution is Mw/Mn=1.3. The pH value of the aramid polymer dope is 7.8.

Step 2: preparing a covalently crosslinked aramid dope: adding diethylamine as an organic base into the aramid polymer dope in step 1 to perform deprotonation, and stirring for 1 hour, where the concentration of the diethylamine is 15% of the molar mass of the aramid amide bond; and then adding 1,6-dibromohexane as a crosslinking agent to perform a covalent crosslinking reaction, where the concentration of the 1,6-dibromohexane is 5% of the molar mass of the aramid amide; and performing a covalent crosslinking reaction at a room temperature for 10 minutes to obtain the covalently crosslinked aramid dope.

Before the organic base is added to the aramid polymer dope, the organic base is dissolved in a first solvent, that is, N,N-dimethylacetamide (DMAc), to obtain an organic base solution. The mass concentration of the organic base in the organic base solution is 30%.

The viscosity of the covalently crosslinked aramid dope is 540 Pa·s. The pH value of the covalently crosslinked aramid dope is 8.4.

Step 3: preparing a modified aramid dope: Adding a polar polymer into the covalently crosslinked aramid dope prepared in step 2, and stirring the mixture at a room temperature at a speed of 900 r/min for a duration of 30 minutes. In this embodiment, the polar polymer is polyacrylic acid (PAA) with a number-average molecular weight (y) of 2000 and polyacrylamide (PAM) with a number-average molecular weight of 2000 that are mixed well. The concentration of the polyacrylic acid and the concentration of the polyacrylamide each are 5% of the molar mass of the aramid amide bond. In this way, non-covalent crosslinks are formed during protonation, so as to obtain the modified aramid dope.

In the above process, before the polar polymer is added to the covalently crosslinked aramid dope, the polar polymer is dissolved in a second solvent, that is, N,N-dimethylacetamide (DMAc), to obtain a polar polymer solution. The mass concentration of the polar polymer in the polar polymer solution is 30%.

The viscosity of the modified aramid dope is 550 Pa·s. The pH value of the modified aramid dope is 7.3.

In this embodiment, the amide bonds that undergo covalent crosslinking and non-covalent crosslinking account for 15% of the total mass of the amide bonds in the aramid polymer.

### Embodiment 12

This embodiment provides a method for preparing a modified aramid dope, including the following steps.

Step 1: preparing an aramid polymer dope: performing a polymerization reaction between phthaloyl chloride and phenylenediamine at a molar ratio of 1.02:1 in an organic solvent under polymerization conditions, and specifically, dissolving 300 mol of m-phenylenediamine in an organic solvent N,N-dimethylacetamide (DMAc) to formulate an m-phenylenediamine solution at a mass percent of 7.8%, and then adding 306 mol of isophthaloyl chloride to initiate a polymerization reaction to obtain a mixed polymer solution.

The polymerization reaction is divided into a first polymerization step and a second polymerization step.

Specifically, before the polymerization reaction, 306 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, calcium oxide is added as a neutralization agent to neutralize the inorganic acid in the mixed polymer solution, and then the mixture is filtered to obtain the aramid polymer dope.

The mass concentration of the aramid polymer in the aramid polymer dope is 15%. The molar concentration of the aramid amide bond is 0.06 mol/g. The viscosity of the aramid polymer dope is 450 Pa·s. The molecular weight distribution is Mw/Mn=1.5. The pH value of the aramid polymer dope is 7.2.

Step 2: preparing a covalently crosslinked aramid dope: adding diethylamine as an organic base into the aramid polymer dope in step 1 to perform deprotonation, and stirring for 1 hour, where the concentration of the diethylamine is 15% of the molar mass of the aramid amide bond; and then adding 1,6-dibromohexane as a crosslinking agent to perform a covalent crosslinking reaction, where the concentration of the 1,6-dibromohexane is 5% of the molar mass of the aramid amide; and performing a covalent crosslinking reaction at a room temperature for 10 minutes to obtain the covalently crosslinked aramid dope.

Before the organic base is added to the aramid polymer dope, the organic base is dissolved in a first solvent, that is, N,N-dimethylacetamide (DMAc), to obtain an organic base solution. The mass concentration of the organic base in the organic base solution is 30%.

The viscosity of the covalently crosslinked aramid dope is 550 Pa·s. The pH value of the covalently crosslinked aramid dope is 8.3.

Step 3: preparing a modified aramid dope: Adding a polar polymer into the covalently crosslinked aramid dope prepared in step 2, and stirring the mixture at a room temperature at a speed of 850 r/min for a duration of 30 minutes. In this embodiment, the polar polymer is polyacrylamide (PAM) with a number-average molecular weight (y) of 2000 and polyvinyl alcohol (PVA) with a number-average molecular weight of 2000 that are mixed well. The concentration of the polyacrylamide and the concentration of the polyvinyl alcohol each are 5% of the molar mass of the aramid amide bond. In this way, non-covalent crosslinks are formed during protonation, so as to obtain the modified aramid dope.

In the above process, before the polar polymer is added to the covalently crosslinked aramid dope, the polar polymer is dissolved in a second solvent, that is, N,N-dimethylacetamide (DMAc), to obtain a polar polymer solution. The mass concentration of the polar polymer in the polar polymer solution is 30%.

The viscosity of the modified aramid dope is 570 Pa·s. The pH value of the modified aramid dope is 7.1.

In this embodiment, the amide bonds that undergo covalent crosslinking and non-covalent crosslinking account for 15% of the total mass of the amide bonds in the aramid polymer.

### Embodiment 13

This embodiment provides a method for preparing a modified aramid dope, including the following steps.

Step 1: preparing an aramid polymer dope: performing a polymerization reaction between phthaloyl chloride and phenylenediamine at a molar ratio of 1.02:1 in an organic solvent under polymerization conditions, and specifically, dissolving 300 mol of m-phenylenediamine in an organic solvent N-methylpyrrolidone (NMP) to formulate an m-phenylenediamine solution at a mass percent of 7.8%, and then adding 306 mol of isophthaloyl chloride to initiate a polymerization reaction to obtain a mixed polymer solution.

The polymerization reaction is divided into a first polymerization step and a second polymerization step.

Specifically, before the polymerization reaction, 306 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, ammonia is added as a neutralization agent to neutralize the inorganic acid in the mixed polymer solution, and then the mixture is filtered to obtain the aramid polymer dope.

The mass concentration of the aramid polymer in the aramid polymer dope is 15%. The molar concentration of the aramid amide bond is 0.06 mol/g. The viscosity of the aramid polymer dope is 500 Pa·s. The molecular weight distribution is Mw/Mn=1.6. The pH value of the aramid polymer dope is 7.0.

Step 2: preparing a covalently crosslinked aramid dope: adding diethylamine as an organic base into the aramid polymer dope in step 1 to perform deprotonation, and stirring for 1 hour, where the concentration of the diethylamine is 10% of the molar mass of the aramid amide bond; and then adding 1,6-dibromohexane as a crosslinking agent to perform a covalent crosslinking reaction, where the concentration of the 1,6-dibromohexane is 5% of the molar mass of the aramid amide; and performing a covalent crosslinking reaction at a room temperature for 10 minutes to obtain the covalently crosslinked aramid dope.

Before the organic base is added to the aramid polymer dope, the organic base is dissolved in a first solvent, that is, N-methylpyrrolidone (NMP), to obtain an organic base solution. The mass concentration of the organic base in the organic base solution is 30%.

The viscosity of the covalently crosslinked aramid dope is 560 Pa·s. The pH value of the covalently crosslinked aramid dope is 7.5.

Step 3: preparing a modified aramid dope: Adding a polar polymer into the covalently crosslinked aramid dope prepared in step 2, and stirring the mixture at a room temperature at a speed of 850 r/min for a duration of 30 minutes. In this embodiment, the polar polymer is well-mixed polyacrylic acid (PAA) with a number-average molecular weight (y) of 2000. The concentration of the polyacrylic acid (PAA) is 5% of the molar mass of the aramid amide bond. In this way, non-covalent crosslinks are formed during protonation, so as to obtain the modified aramid dope.

In the above process, before the polar polymer is added to the covalently crosslinked aramid dope, the polar polymer is dissolved in a second solvent, that is, N-methylpyrrolidone (NMP), to obtain a polar polymer solution. The mass concentration of the polar polymer in the polar polymer solution is 30%.

The viscosity of the modified aramid dope is 590 Pa·s. The pH value of the modified aramid dope is 7.2.

In this embodiment, the amide bonds that undergo covalent crosslinking and non-covalent crosslinking account for 10% of the total mass of the amide bonds in the aramid polymer.

### Embodiment 14

In this embodiment, an aramid film is prepared from the modified aramid dope prepared in Embodiment 1, and the preparation process includes the following steps.

Step 1: casting the modified aramid dope onto a clean glass substrate to form a film. Specifically, spreading the modified aramid dope to form a film using a film applicator, and then storing the film in a 100° C. blast oven for 20 minutes, and then taking out the film, and peeling the film off from the glass substrate to obtain a cast film. Placing the cast film into a 15° C. washing tank in which the film is washed with water for 10 seconds. Subsequently, transferring the film into a 120° C. oven in which the film is dried for 5 minutes to obtain a preform film.

The mass percent of the solvent in the preform film is 1.5%.

Step 2: performing biaxial stretching and thermal setting on the preform film in two mutually perpendicular directions (that is, TD and MD directions of the preform film) simultaneously to obtain a 125.8 m-thick aramid film, where the stretching temperature is 250° C., the stretch ratio is 2.5, and the thermal setting temperature is 300° C. Of the aramid film, the MD tensile strength is 162.1 MPa, the TD tensile strength is 159.9 MPa, the MD elongation-at-break is 87.6%, the TD elongation-at-break is 86.5%, the MD modulus is 6.4 GPa, the TD modulus is 6.2 GPa, the dielectric strength is 153.3 kV/mm, the hygroscopicity is 3.4%, and the decomposition start temperature is 410° C.

The stretch ratio means a stretch ratio in two mutually perpendicular directions.

### Embodiment 15

In this embodiment, an aramid film is prepared from the modified aramid dope prepared in Embodiment 2, and the preparation process includes the following steps.

Step 1: casting the modified aramid dope onto a clean glass substrate to form a film. Specifically, spreading the modified aramid dope to form a film using a film applicator, and then storing the film in a 150° C. blast oven for 10 minutes, and then taking out the film, and peeling the film off from the glass substrate to obtain a cast film. Placing the cast film into a 45° C. washing tank in which the film is washed with water for 10 seconds. Subsequently, transferring the film into a 90° C. oven in which the film is dried for 30 minutes to obtain a preform film.

The mass percent of the solvent in the preform film is 0.8%.

Step 2: performing biaxial stretching and thermal setting on the preform film in two mutually perpendicular directions (that is, TD and MD directions of the preform film) simultaneously to obtain a 120.0 m-thick aramid film, where the stretching temperature is 250° C., the stretch ratio is 2.5, and the thermal setting temperature is 300° C. Of the aramid film, the MD tensile strength is 158.9 MPa, the TD tensile strength is 157.7 MPa, the MD elongation-at-break is 90.9%, the TD elongation-at-break is 89.3%, the MD modulus is 6.0 GPa, the TD modulus is 5.9 GPa, the dielectric strength is 166.7 kV/mm, the hygroscopicity is 3.5%, and the decomposition start temperature is 425° C.

The stretch ratio means a stretch ratio in two mutually perpendicular directions.

### Embodiment 16

In this embodiment, an aramid film is prepared from the modified aramid dope prepared in Embodiment 3, and the preparation process includes the following steps.

Step 1: casting the modified aramid dope onto a clean glass substrate to form a film. Specifically, spreading the modified aramid dope to form a film using a film applicator, and then storing the film in a 200° C. blast oven for 5 minutes, and then taking out the film, and peeling the film off from the glass substrate to obtain a cast film. Placing the cast film into a 25° C. washing tank in which the film is washed with water for 30 seconds. Subsequently, transferring the film into a 120° C. oven in which the film is dried for 15 minutes to obtain a preform film.

The mass percent of the solvent in the preform film is 1.0%.

Step 2: performing biaxial stretching and thermal setting on the preform film in two mutually perpendicular directions (that is, TD and MD directions of the preform film) simultaneously to obtain a 130.3 m-thick aramid film, where the stretching temperature is 200° C., the stretch ratio is 2.3, and the thermal setting temperature is 250° C. Of the aramid film, the MD tensile strength is 155.7 MPa, the TD tensile strength is 155.7 MPa, the MD elongation-at-break is 83.3%, the TD elongation-at-break is 83.0%, the MD modulus is 5.6 GPa, the TD modulus is 5.4 GPa, the dielectric strength is 165.7 kV/mm, the hygroscopicity is 3.6%, and the decomposition start temperature is 426° C.

The stretch ratio means a stretch ratio in two mutually perpendicular directions.

### Embodiment 17

In this embodiment, an aramid film is prepared from the modified aramid dope prepared in Embodiment 4, and the preparation process includes the following steps.

Step 1: casting the modified aramid dope onto a clean glass substrate to form a film. Specifically, spreading the modified aramid dope to form a film using a film applicator, and then storing the film in a 100° C. blast oven for 20 minutes, and then taking out the film, and peeling the film off from the glass substrate to obtain a cast film. Placing the cast film into a 25° C. washing tank in which the film is washed with water for 30 seconds. Subsequently, transferring the film into a 120° C. oven in which the film is dried for 15 minutes to obtain a preform film.

The mass percent of the solvent in the preform film is 0.9%.

Step 2: performing biaxial stretching and thermal setting on the preform film in two mutually perpendicular directions (that is, TD and MD directions of the preform film) simultaneously to obtain a 180.1 m-thick aramid film, where the stretching temperature is 250° C., the stretch ratio is 2, and the thermal setting temperature is 300° C. Of the aramid film, the MD tensile strength is 160.3 MPa, the TD tensile strength is 158.9 MPa, the MD elongation-at-break is 85.6%, the TD elongation-at-break is 84.0%, the MD modulus is 6.1 GPa, the TD modulus is 6.0 GPa, the dielectric strength is 154.2 kV/mm, the hygroscopicity is 3.5%, and the decomposition start temperature is 415° C.

The stretch ratio means a stretch ratio in two mutually perpendicular directions.

### Embodiment 18

In this embodiment, an aramid film is prepared from the modified aramid dope prepared in Embodiment 5, and the preparation process includes the following steps.

Step 1: casting the modified aramid dope onto a clean glass substrate to form a film. Specifically, spreading the modified aramid dope to form a film using a film applicator, and then storing the film in a 150° C. blast oven for 15 minutes, and then taking out the film, and peeling the film off from the glass substrate to obtain a cast film. Placing the cast film into a 30° C. washing tank in which the film is washed with water for 30 seconds. Subsequently, transferring the film into a 120° C. oven in which the film is dried for 15 minutes to obtain a preform film.

The mass percent of the solvent in the preform film is 1.5%.

Step 2: performing biaxial stretching and thermal setting on the preform film in two mutually perpendicular directions (that is, TD and MD directions of the preform film) simultaneously to obtain a 130.7 m-thick aramid film, where the stretching temperature is 250° C., the stretch ratio is 2, and the thermal setting temperature is 300° C. Of the aramid film, the MD tensile strength is 158.2 MPa, the TD tensile strength is 157.0 MPa, the MD elongation-at-break is 90.7%, the TD elongation-at-break is 89.5%, the MD modulus is 5.8 GPa, the TD modulus is 5.7 GPa, the dielectric strength is 171.5 kV/mm, the hygroscopicity is 3.5%, and the decomposition start temperature is 421° C.

The stretch ratio means a stretch ratio in two mutually perpendicular directions.

### Embodiment 19

In this embodiment, an aramid film is prepared from the modified aramid dope prepared in Embodiment 6, and the preparation process includes the following steps.

Step 1: casting the modified aramid dope onto a clean glass substrate to form a film. Specifically, spreading the modified aramid dope to form a film using a film applicator, and then storing the film in a 100° C. blast oven for 10 minutes, and then taking out the film, and peeling the film off from the glass substrate to obtain a cast film. Placing the cast film into a 15° C. washing tank in which the film is washed with water for 30 seconds. Subsequently, transferring the film into a 120° C. oven in which the film is dried for 20 minutes to obtain a preform film.

The mass percent of the solvent in the preform film is 0.6%.

Step 2: performing biaxial stretching and thermal setting on the preform film in two mutually perpendicular directions (that is, TD and MD directions of the preform film) simultaneously to obtain a 200.1 m-thick aramid film, where the stretching temperature is 250° C., the stretch ratio is 2.5, and the thermal setting temperature is 300° C. Of the aramid film, the MD tensile strength is 153.3 MPa, the TD tensile strength is 151.5 MPa, the MD elongation-at-break is 84.5%, the TD elongation-at-break is 83.0%, the MD modulus is 5.2 GPa, the TD modulus is 5.1 GPa, the dielectric strength is 157.6 kV/mm, the hygroscopicity is 3.6%, and the decomposition start temperature is 419° C.

The stretch ratio means a stretch ratio in two mutually perpendicular directions.

### Embodiment 20

In this embodiment, an aramid film is prepared from the modified aramid dope prepared in Embodiment 7, and the preparation process includes the following steps.

Step 1: casting the modified aramid dope onto a clean glass substrate to form a film. Specifically, spreading the modified aramid dope to form a film using a film applicator, and then storing the film in a 100° C. blast oven for 20 minutes, and then taking out the film, and peeling the film off from the glass substrate to obtain a cast film. Placing the cast film into a 25° C. washing tank in which the film is washed with water for 30 seconds. Subsequently, transferring the film into a 120° C. oven in which the film is dried for 15 minutes to obtain a preform film.

The mass percent of the solvent in the preform film is 1.2%.

Step 2: performing biaxial stretching and thermal setting on the preform film in two mutually perpendicular directions (that is, TD and MD directions of the preform film) simultaneously to obtain a 150.9 m-thick aramid film, where the stretching temperature is 250° C., the stretch ratio is 1.5, and the thermal setting temperature is 300° C. Of the aramid film, the MD tensile strength is 155.8 MPa, the TD tensile strength is 153.7 MPa, the MD elongation-at-break is 93.9%, the TD elongation-at-break is 92.0%, the MD modulus is 5.5 GPa, the TD modulus is 5.4 GPa, the dielectric strength is 160.8 kV/mm, the hygroscopicity is 3.4%, and the decomposition start temperature is 424° C.

The stretch ratio means a stretch ratio in two mutually perpendicular directions.

### Embodiment 21

In this embodiment, an aramid film is prepared from the modified aramid dope prepared in Embodiment 8, and the preparation process includes the following steps.

Step 1: casting the modified aramid dope onto a clean glass substrate to form a film. Specifically, spreading the modified aramid dope to form a film using a film applicator, and then storing the film in a 150° C. blast oven for 20 minutes, and then taking out the film, and peeling the film off from the glass substrate to obtain a cast film. Placing the cast film into a 35° C. washing tank in which the film is washed with water for 100 seconds. Subsequently, transferring the film into a 150° C. oven in which the film is dried for 30 minutes to obtain a preform film.

The mass percent of the solvent in the preform film is 0.5%.

Step 2: performing biaxial stretching and thermal setting on the preform film in two mutually perpendicular directions (that is, TD and MD directions of the preform film) simultaneously to obtain a 180.0 m-thick aramid film, where the stretching temperature is 250° C., the stretch ratio is 1.1, and the thermal setting temperature is 300° C. Of the aramid film, the MD tensile strength is 151.0 MPa, the TD tensile strength is 150.2 MPa, the MD elongation-at-break is 81.0%, the TD elongation-at-break is 80.1%, the MD modulus is 5.2 GPa, the TD modulus is 5.1 GPa, the dielectric strength is 169.7 kV/mm, the hygroscopicity is 3.1%, and the decomposition start temperature is 422° C.

The stretch ratio means a stretch ratio in two mutually perpendicular directions.

### Embodiment 22

In this embodiment, an aramid film is prepared from the modified aramid dope prepared in Embodiment 9, and the preparation process includes the following steps.

Step 1: casting the modified aramid dope onto a clean glass substrate to form a film. Specifically, spreading the modified aramid dope to form a film using a film applicator, and then storing the film in a 100° C. blast oven for 20 minutes, and then taking out the film, and peeling the film off from the glass substrate to obtain a cast film. Placing the cast film into a 25° C. washing tank in which the film is washed with water for 30 seconds. Subsequently, transferring the film into a 120° C. oven in which the film is dried for 15 minutes to obtain a preform film.

The mass percent of the solvent in the preform film is 0.9%.

Step 2: performing biaxial stretching and thermal setting on the preform film in two mutually perpendicular directions (that is, TD and MD directions of the preform film) simultaneously to obtain a 125.4 km-thick aramid film, where the stretching temperature is 250° C., the stretch ratio is 1.5, and the thermal setting temperature is 300° C. Of the aramid film, the MD tensile strength is 160.2 MPa, the TD tensile strength is 159.5 MPa, the MD elongation-at-break is 98.4%, the TD elongation-at-break is 97.0%, the MD modulus is 6.0 GPa, the TD modulus is 5.9 GPa, the dielectric strength is 168.0 kV/mm, the hygroscopicity is 3.2%, and the decomposition start temperature is 425° C.

The stretch ratio means a stretch ratio in two mutually perpendicular directions.

### Embodiment 23

In this embodiment, an aramid film is prepared from the modified aramid dope prepared in Embodiment 10, and the preparation process includes the following steps.

Step 1: casting the modified aramid dope onto a clean glass substrate to form a film. Specifically, spreading the modified aramid dope to form a film using a film applicator, and then storing the film in a 100° C. blast oven for 5 minutes, and then taking out the film, and peeling the film off from the glass substrate to obtain a cast film. Placing the cast film into a 45° C. washing tank in which the film is washed with water for 5 seconds. Subsequently, transferring the film into a 90° C. oven in which the film is dried for 5 minutes to obtain a preform film.

The mass percent of the solvent in the preform film is 0.5%.

Step 2: performing biaxial stretching and thermal setting on the preform film in two mutually perpendicular directions (that is, TD and MD directions of the preform film) simultaneously to obtain a 120.1 m-thick aramid film, where the stretching temperature is 130° C., the stretch ratio is 1.1, and the thermal setting temperature is 250° C. Of the aramid film, the MD tensile strength is 155.8 MPa, the TD tensile strength is 153.1 MPa, the MD elongation-at-break is 88.9%, the TD elongation-at-break is 86.8%, the MD modulus is 5.4 GPa, the TD modulus is 5.3 GPa, the dielectric strength is 156.3 kV/mm, the hygroscopicity is 3.4%, and the decomposition start temperature is 418° C.

The stretch ratio means a stretch ratio in two mutually perpendicular directions.

### Embodiment 24

In this embodiment, an aramid film is prepared from the modified aramid dope prepared in Embodiment 11, and the preparation process includes the following steps.

Step 1: casting the modified aramid dope onto a clean glass substrate to form a film. Specifically, spreading the modified aramid dope to form a film using a film applicator, and then storing the film in a 100° C. blast oven for 20 minutes, and then taking out the film, and peeling the film off from the glass substrate to obtain a cast film. Placing the cast film into a 25° C. washing tank in which the film is washed with water for 30 seconds. Subsequently, transferring the film into a 120° C. oven in which the film is dried for 15 minutes to obtain a preform film.

The mass percent of the solvent in the preform film is 1.0%.

Step 2: performing biaxial stretching and thermal setting on the preform film in two mutually perpendicular directions (that is, TD and MD directions of the preform film) simultaneously to obtain a 150.5 m-thick aramid film, where the stretching temperature is 250° C., the stretch ratio is 1.5, and the thermal setting temperature is 300° C. Of the aramid film, the MD tensile strength is 150.8 MPa, the TD tensile strength is 152.3 MPa, the MD elongation-at-break is 95.8%, the TD elongation-at-break is 94.7%, the MD modulus is 5.3 GPa, the TD modulus is 5.4 GPa, the dielectric strength is 157.9 kV/mm, the hygroscopicity is 3.7%, and the decomposition start temperature is 420° C.

The stretch ratio means a stretch ratio in two mutually perpendicular directions.

### Embodiment 25

In this embodiment, an aramid film is prepared from the modified aramid dope prepared in Embodiment 12, and the preparation process includes the following steps.

Step 1: casting the modified aramid dope onto a clean glass substrate to form a film. Specifically, spreading the modified aramid dope to form a film using a film applicator, and then storing the film in a 100° C. blast oven for 20 minutes, and then taking out the film, and peeling the film off from the glass substrate to obtain a cast film. Placing the cast film into a 15° C. washing tank in which the film is washed with water for 180 seconds. Subsequently, transferring the film into a 110° C. oven in which the film is dried for 30 minutes to obtain a preform film.

The mass percent of the solvent in the preform film is 1.0%.

Step 2: performing biaxial stretching and thermal setting on the preform film in two mutually perpendicular directions (that is, TD and MD directions of the preform film) simultaneously to obtain a 130.2 m-thick aramid film, where the stretching temperature is 130° C., the stretch ratio is 1.1, and the thermal setting temperature is 300° C. Of the aramid film, the MD tensile strength is 151.0 MPa, the TD tensile strength is 150.5 MPa, the MD elongation-at-break is 88.3%, the TD elongation-at-break is 86.2%, the MD modulus is 5.3 GPa, the TD modulus is 5.2 GPa, the dielectric strength is 150.8 kV/mm, the hygroscopicity is 3.9%, and the decomposition start temperature is 411° C.

The stretch ratio means a stretch ratio in two mutually perpendicular directions.

### Embodiment 26

In this embodiment, an aramid film is prepared from the modified aramid dope prepared in Embodiment 13, and the preparation process includes the following steps.

Step 1: casting the modified aramid dope onto a clean glass substrate to form a film. Specifically, spreading the modified aramid dope to form a film using a film applicator, and then storing the film in a 100° C. blast oven for 20 minutes, and then taking out the film, and peeling the film off from the glass substrate to obtain a cast film. Placing the cast film into a 25° C. washing tank in which the film is washed with water for 30 seconds. Subsequently, transferring the film into a 110° C. oven in which the film is dried for 30 minutes to obtain a preform film.

The mass percent of the solvent in the preform film is 0.8%.

Step 2: performing biaxial stretching and thermal setting on the preform film in two mutually perpendicular directions (that is, TD and MD directions of the preform film) simultaneously to obtain a 140.2 m-thick aramid film, where the stretching temperature is 200° C., the stretch ratio is 1.1, and the thermal setting temperature is 300° C. Of the aramid film, the MD tensile strength is 170.3 MPa, the TD tensile strength is 169.8 MPa, the MD elongation-at-break is 80.5%, the TD elongation-at-break is 80.3%, the MD modulus is 6.7 GPa, the TD modulus is 6.7 GPa, the dielectric strength is 152.7 kV/mm, the hygroscopicity is 3.1%, and the decomposition start temperature is 420° C.

The stretch ratio means a stretch ratio in two mutually perpendicular directions.

### Embodiment 27

In this embodiment, the aramid film prepared in Embodiment 22 is directly laminated with aramid paper. The upper layer and the lower layer are aramid paper, and the middle layer is the aramid film. As can be seen from the FIGURE, without requiring an adhesive, the aramid paper and the aramid film can be laminated to obtain a composite material of an insulation class F.

### Embodiment 28

In this embodiment, the aramid film prepared in Embodiment 26 is directly laminated with aramid paper. The upper layer and the lower layer are aramid paper, and the middle layer is the aramid film. Without requiring an adhesive, the aramid paper and the aramid film can be laminated to obtain a composite material of an insulation class H.

### Comparative Embodiment 1

In this comparative embodiment, phthaloyl chloride and phenylenediamine are directly polymerized to prepare dope I, without covalent and non-covalent crosslinking. The process includes the following specific steps.

Performing a polymerization reaction between phthaloyl chloride and phenylenediamine at a molar ratio of 1.02:1 in an organic solvent under polymerization conditions, and specifically, dissolving 300 mol of m-phenylenediamine in an organic solvent N,N-dimethylacetamide (DMAc) to formulate an m-phenylenediamine solution at a mass percent of 7.8%, and then adding 306 mol of isophthaloyl chloride to initiate a polymerization reaction to obtain a mixed polymer solution.

The polymerization reaction is divided into a first polymerization step and a second polymerization step.

Specifically, before the polymerization reaction, 306 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, calcium hydroxide is added as a neutralization agent to neutralize the inorganic acid in the mixed polymer solution, and then the mixture is filtered to obtain dope I in this comparative embodiment.

The mass concentration of the aramid polymer in the dope I is 15%, the viscosity of the dope I is 600 Pa·s, the molecular weight distribution is Mw/Mn=1.2, and the pH value of the dope is 7.5.

### Comparative Embodiment 2

In this comparative embodiment, phthaloyl chloride and phenylenediamine are directly polymerized to prepare dope II, without covalent and non-covalent crosslinking. The process includes the following specific steps.

Performing a polymerization reaction between phthaloyl chloride and phenylenediamine at a molar ratio of 1.02:1 in an organic solvent under polymerization conditions, and specifically, dissolving 300 mol of p-phenylenediamine in an organic solvent N,N-dimethylacetamide (DMAc) to formulate a p-phenylenediamine solution at a mass percent of 7.8%, and then adding 306 mol of isophthaloyl chloride to initiate a polymerization reaction to obtain a mixed polymer solution.

The polymerization reaction is divided into a first polymerization step and a second polymerization step.

Specifically, before the polymerization reaction, 306 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into a p-phenylenediamine solution. In the first polymerization step, the temperature is controlled to be 5±1° C., the stirring speed is 500 r/min, and the reaction time is 30 minutes.

Subsequently, a second portion of phthaloyl chloride is added into the above system. In the second polymerization step, the temperature is controlled to be 50° C., the stirring speed is 500 r/min, and the reaction time is 15 min.

The total time of the polymerization reaction is 45 minutes. The polymerization reaction is a polycondensation reaction.

After completion of the reaction, calcium oxide is added as a neutralization agent to neutralize the inorganic acid in the mixed polymer solution, and then the mixture is filtered to obtain dope II in this comparative embodiment.

The mass concentration of the aramid polymer in the dope II is 15%, the viscosity of the dope II is 550 Pa·s, the molecular weight distribution is Mw/Mn=1.4, and the pH value of the dope is 7.4.

### Comparative Embodiment 3

In this comparative embodiment, phthaloyl chloride and phenylenediamine are first polymerized to prepare dope III, and then are covalently crosslinked, but without non-covalent crosslinking. The process includes the following specific steps.

Step 1: performing a polymerization reaction between phthaloyl chloride and phenylenediamine at a molar ratio of 1.02:1 in an organic solvent under polymerization conditions, and specifically, dissolving 300 mol of m-phenylenediamine in an organic solvent N,N-dimethylacetamide (DMAc) to formulate an m-phenylenediamine solution at a mass percent of 7.8%, and then adding 306 mol of isophthaloyl chloride to initiate a polymerization reaction to obtain a mixed polymer solution.

The polymerization reaction is divided into a first polymerization step and a second polymerization step.

Specifically, before the polymerization reaction, 306 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, calcium oxide is added as a neutralization agent to neutralize the inorganic acid in the mixed polymer solution, and then the mixture is filtered to obtain dope III in this comparative embodiment.

The mass concentration of the aramid polymer in the dope III is 15%, the viscosity of the dope III is 500 Pa·s, the molecular weight distribution is Mw/Mn=1.4, and the pH value of the dope is 7.1.

Step 2: preparing a covalently crosslinked aramid dope: adding diethylamine as an organic base into dope III prepared in step 1 to perform deprotonation, and stirring for 1 hour, where the concentration of the diethylamine is 10% of the molar mass of the aramid amide bond; and then adding 1,6-dibromohexane as a crosslinking agent to perform a covalent crosslinking reaction, where the concentration of the 1,6-dibromohexane is 10% of the molar mass of the aramid amide; and performing a covalent crosslinking reaction at a room temperature for 10 minutes to obtain the covalently crosslinked aramid dope III.

Before the organic base is added to dope III, the organic base is dissolved in a first solvent, that is, N,N-dimethylacetamide (DMAc), to obtain an organic base solution. The mass concentration of the organic base in the organic base solution is 30%.

The viscosity of the covalently crosslinked aramid dope is 650 Pa·s. The pH value of the covalently crosslinked aramid dope is 8.

### Comparative Embodiment 4

In this comparative embodiment, phthaloyl chloride and phenylenediamine are first polymerized to prepare dope IV, and then are non-covalently crosslinked, but without covalent crosslinking. The process includes the following specific steps.

Step 1: performing a polymerization reaction between phthaloyl chloride and phenylenediamine at a molar ratio of 1.02:1 in an organic solvent under polymerization conditions, and specifically, dissolving 300 mol of m-phenylenediamine in an organic solvent N,N-dimethylacetamide (DMAc) to formulate an m-phenylenediamine solution at a mass percent of 7.8%, and then adding 306 mol of isophthaloyl chloride to initiate a polymerization reaction to obtain a mixed polymer solution.

The polymerization reaction is divided into a first polymerization step and a second polymerization step.

Specifically, before the polymerization reaction, 306 mol of isophthaloyl chloride is divided into a first portion of phthaloyl chloride and a second portion of phthaloyl chloride at a mass ratio of 9:1. The first portion of phthaloyl chloride is used for the first polymerization step, and the second portion of phthaloyl chloride is used for the second polymerization step.

The first polymerization step is to add the first portion of phthaloyl chloride into an m-phenylenediamine solution. In the first polymerization step, the temperature is controlled to be 10±1° C., the stirring speed is 500 r/min, and the reaction time is 30 minutes.

Subsequently, a second portion of phthaloyl chloride is added into the above system. In the second polymerization step, the temperature is controlled to be 55° C., the stirring speed is 500 r/min, and the reaction time is 15 min.

The total time of the polymerization reaction is 45 minutes. The polymerization reaction is a polycondensation reaction.

After completion of the reaction, calcium oxide is added as a neutralization agent to neutralize the inorganic acid in the mixed polymer solution, and then the mixture is filtered to obtain dope IV in this comparative embodiment.

The mass concentration of the aramid polymer in the dope IV is 15%, the viscosity of the dope IV is 510 Pa·s, the molecular weight distribution is Mw/Mn=1.6, and the pH value of the dope is 7.1.

Step 2: deprotonating dope IV: adding diethylamine as an organic base into dope IV prepared in step 1 to perform deprotonation, and stirring for 1 hour to obtain deprotonated dope IV, where the concentration of the diethylamine is 10% of the molar mass of the aramid amide bond.

Before the organic base is added to dope IV, the organic base is dissolved in a first solvent, that is, N-methylpyrrolidone (NMP), to obtain an organic base solution. The mass concentration of the organic base in the organic base solution is 30%.

Step 3: preparing a non-covalently crosslinked dope IV: Adding a polar polymer into the deprotonated dope IV prepared in step 2, and stirring the mixture at a room temperature at a speed of 700 r/min for a duration of 30 minutes. In this comparative embodiment, the polar polymer is well-mixed polyacrylic acid with a number-average molecular weight (y) of 2000. The concentration of the polyacrylic acid (PAA) is 10% of the molar mass of the aramid amide bond. In this way, non-covalent crosslinks are formed during protonation, so as to obtain the non-covalently crosslinked dope IV.

In the above process, before the polar polymer is added to the deprotonated dope IV, the polar polymer is dissolved in a second solvent, that is, N,N-dimethylacetamide (DMAc), to obtain a polar polymer solution. The mass concentration of the polar polymer in the polar polymer solution is 30%.

The viscosity of the non-covalently crosslinked dope IV is 530 Pa·s. The pH value of the dope is 7.2.

### Comparative Embodiment 5

In this comparative embodiment, an aramid film is prepared from the modified aramid dope prepared in Comparative Embodiment 1, and the preparation process includes the following steps.

Step 1: casting the dope onto a clean glass substrate to form a film. Specifically, spreading the modified aramid dope to form a film using a film applicator, and then storing the film in a 100° C. blast oven for 20 minutes, and then taking out the film, and peeling the film off from the glass substrate to obtain a cast film. Placing the cast film into a 25° C. washing tank in which the film is washed with water for 30 seconds. Subsequently, transferring the film into a 120° C. oven in which the film is dried for 15 minutes to obtain a preform film.

The mass percent of the solvent in the preform film is 0.8%.

Step 2: performing biaxial stretching and thermal setting on the preform film in two mutually perpendicular directions (that is, TD and MD directions of the preform film) simultaneously to obtain a 130.3 km-thick aramid film, where the stretching temperature is 250° C., the stretch ratio is 2.5, and the thermal setting temperature is 300° C. Of the aramid film, the MD tensile strength is 120.6 MPa, the TD tensile strength is 120.4 MPa, the MD elongation-at-break is 22.2%, the TD elongation-at-break is 21.3%, the MD modulus is 2.9 GPa, the TD modulus is 2.7 GPa, the dielectric strength is 103.6 kV/mm, the hygroscopicity is 4.2%, and the decomposition start temperature is 430° C.

The stretch ratio means a stretch ratio in two mutually perpendicular directions.

### Comparative Embodiment 6

In this comparative embodiment, an aramid film is prepared from the modified aramid dope prepared in Comparative Embodiment 2, and the preparation process includes the following steps:

Step 1: casting the dope onto a clean glass substrate to form a film. Specifically, spreading the modified aramid dope to form a film using a film applicator, and then storing the film in a 100° C. blast oven for 20 minutes, and then taking out the film, and peeling the film off from the glass substrate to obtain a cast film. Placing the cast film into a 25° C. washing tank in which the film is washed with water for 30 seconds. Subsequently, transferring the film into a 120° C. oven in which the film is dried for 15 minutes to obtain a preform film.

The mass percent of the solvent in the preform film is 0.6%.

Step 2: performing biaxial stretching and thermal setting on the preform film in two mutually perpendicular directions (that is, TD and MD directions of the preform film) simultaneously to obtain a 140.3 km-thick aramid film, where the stretching temperature is 200° C., the stretch ratio is 1.2, and the thermal setting temperature is 300° C. Of the aramid film, the MD tensile strength is 140.5 MPa, the TD tensile strength is 141.5 MPa, the MD elongation-at-break is 30.5%, the TD elongation-at-break is 29.5%, the MD modulus is 4.8 GPa, the TD modulus is 4.9 GPa, the dielectric strength is 110.3 kV/mm, the hygroscopicity is 3.9%, and the decomposition start temperature is 429° C.

The stretch ratio means a stretch ratio in two mutually perpendicular directions.

### Comparative Embodiment 7

In this comparative embodiment, an aramid film is prepared from the modified aramid dope prepared in Comparative Embodiment 3, and the preparation process includes the following steps:

Step 1: casting the dope onto a clean glass substrate to form a film. Specifically, spreading the modified aramid dope to form a film using a film applicator, and then storing the film in a 150° C. blast oven for 15 minutes, and then taking out the film, and peeling the film off from the glass substrate to obtain a cast film. Placing the cast film into a 30° C. washing tank in which the film is washed with water for 30 seconds. Subsequently, transferring the film into a 120° C. oven in which the film is dried for 15 minutes to obtain a preform film.

The mass percent of the solvent in the preform film is 1.2%.

Step 2: performing biaxial stretching and thermal setting on the preform film in two mutually perpendicular directions (that is, TD and MD directions of the preform film) simultaneously to obtain a 120.0 m-thick aramid film, where the stretching temperature is 250° C., the stretch ratio is 2, and the thermal setting temperature is 300° C. Of the aramid film, the MD tensile strength is 127.6 MPa, the TD tensile strength is 126.4 MPa, the MD elongation-at-break is 41.3%, the TD elongation-at-break is 40.2%, the MD modulus is 3.2 GPa, the TD modulus is 3.1 GPa, the dielectric strength is 108.8 kV/mm, the hygroscopicity is 4.0%, and the decomposition start temperature is 405° C.

The stretch ratio means a stretch ratio in two mutually perpendicular directions.

### Comparative Embodiment 8

In this comparative embodiment, an aramid film is prepared from the modified aramid dope prepared in Comparative Embodiment 4, and the preparation process includes the following steps:

Step 1: casting the dope onto a clean glass substrate to form a film. Specifically, spreading the modified aramid dope to form a film using a film applicator, and then storing the film in a 100° C. blast oven for 15 minutes, and then taking out the film, and peeling the film off from the glass substrate to obtain a cast film. Placing the cast film into a 20° C. washing tank in which the film is washed with water for 30 seconds. Subsequently, transferring the film into a 150° C. oven in which the film is dried for 15 minutes to obtain a preform film.

The mass percent of the solvent in the preform film is 0.5%.

Step 2: performing biaxial stretching and thermal setting on the preform film in two mutually perpendicular directions (that is, TD and MD directions of the preform film) simultaneously to obtain a 150.6 m-thick aramid film, where the stretching temperature is 250° C., the stretch ratio is 2.5, and the thermal setting temperature is 300° C. Of the aramid film, the MD tensile strength is 129.5 MPa, the TD tensile strength is 128.8 MPa, the MD elongation-at-break is 32.5%, the TD elongation-at-break is 31.8%, the MD modulus is 3.5 GPa, the TD modulus is 3.4 GPa, the dielectric strength is 111.5 kV/mm, the hygroscopicity is 3.8%, and the decomposition start temperature is 409° C.

The stretch ratio means a stretch ratio in two mutually perpendicular directions.

### Comparative Embodiment 9

The film used in this comparative embodiment is a PI film specimen purchased from Tianjin Jiayi, a China-based manufacturer. Of the film specimen, the thickness is 125.0 m, the MD tensile strength is 162.4 MPa, the TD tensile strength is 135.9 MPa, the MD elongation-at-break is 112.0%, the TD elongation-at-break is 89.5%, the MD modulus is 2.5 GPa, the TD modulus is 2.6 GPa, the dielectric strength is 124.6 kV/mm, the hygroscopicity is 2.5%, and the decomposition start temperature is 500° C.

Table 1 shows the performance data of the film prepared in embodiments versus comparative embodiments.

The aramid films obtained in the above embodiments and comparative embodiments are tested using the following method:

The thickness is tested based on ASTM D374 Standard Test Methods for Thickness of Solid Electrical Insulators.

The mechanical properties of the film are tested based on ASTM D882 Standard Test Methods for Tensile Properties of Thin Plastic Sheets.

The dielectric properties are tested based on ASTM D149 Test Methods for Dielectric Strength of Solid Electrical Insulators.

The heat resistance is tested based on ATSM E2550 Standard Test Methods for Thermal Stability by Thermogravimetry.

The hygroscopicity is tested based on ATSM D5229/D5229M Test Methods for Moisture Absorption Properties and Equilibrium Conditioning of Polymer Matrix Composite Materials.

TABLE 1
Performance data of aramid films of embodiments versus comparative embodiments

| | | | | | | | | | | Decomposition |
|---|---|---|---|---|---|---|---|---|---|---|
| | | Tensile | | Elongation-at- | | Modulus | | Dielectric | | start |
| Serial | Thickness | strength (MPa) | | break (%) | | (GPa) | | strength | Hygroscopicity | temperature |
| number | (μm) | MD | TD | MD | TD | MD | TD | (kV/mm) | (%) | (° C.) |
| Embodiment | 125.8 | 162.1 | 159.9 | 87.6 | 86.5 | 6.4 | 6.2 | 153.3 | 3.4 | 410 |
| 14 | | | | | | | | | | |
| Embodiment | 120.0 | 158.9 | 157.7 | 190.9 | 89.3 | 6.0 | 5.9 | 166.7 | 3.5 | 425 |
| 15 | | | | | | | | | | |
| Embodiment | 130.3 | 155.7 | 155.7 | 83.3 | 83.0 | 5.6 | 5.4 | 165.7 | 3.6 | 426 |
| 16 | | | | | | | | | | |
| Embodiment | 180.1 | 160.3 | 158.9 | 85.6 | 84.0 | 6.1 | 6.0 | 154.2 | 3.5 | 415 |
| 17 | | | | | | | | | | |
| Embodiment | 130.7 | 158.2 | 157.0 | 90.7 | 89.5 | 5.8 | 5.7 | 171.5 | 3.5 | 421 |
| 18 | | | | | | | | | | |
| Embodiment | 200.1 | 153.3 | 151.5 | 84.5 | 83.0 | 5.2 | 5.1 | 157.6 | 3.6 | 419 |
| 19 | | | | | | | | | | |
| Embodiment | 150.9 | 155.8 | 153.7 | 93.9 | 92.0 | 5.5 | 5.4 | 160.8 | 3.4 | 424 |
| 20 | | | | | | | | | | |
| Embodiment | 180.0 | 151.0 | 150.2 | 81.0 | 80.1 | 5.2 | 5.1 | 169.7 | 3.1 | 422 |
| 21 | | | | | | | | | | |
| Embodiment | 125.4 | 160.2 | 159.5 | 98.4 | 97.0 | 6.0 | 5.9 | 168.0 | 3.2 | 425 |
| 22 | | | | | | | | | | |
| Embodiment | 120.1 | 155.8 | 153.1 | 88.9 | 86.8 | 5.4 | 5.3 | 156.3 | 3.4 | 418 |
| 23 | | | | | | | | | | |
| Embodiment | 150.5 | 150.8 | 152.3 | 95.8 | 94.7 | 5.3 | 5.4 | 157.9 | 3.7 | 420 |
| 24 | | | | | | | | | | |
| Embodiment | 130.2 | 151.0 | 150.5 | 88.3 | 86.2 | 5.3 | 5.2 | 150.8 | 3.9 | 411 |
| 25 | | | | | | | | | | |
| Embodiment | 140.2 | 170.3 | 169.8 | 80.5 | 80.3 | 6.7 | 6.7 | 152.7 | 3.1 | 420 |
| 26 | | | | | | | | | | |
| Comparative | 130.3 | 120.6 | 120.4 | 22.2 | 21.3 | 2.9 | 2.7 | 103.6 | 4.2 | 430 |
| Embodiment 5 | | | | | | | | | | |
| Comparative | 140.3 | 140.5 | 141.5 | 30.5 | 29.5 | 4.8 | 4.9 | 110.3 | 3.9 | 429 |
| Embodiment 6 | | | | | | | | | | |
| Comparative | 120.0 | 127.6 | 126.4 | 41.3 | 40.2 | 3.2 | 3.1 | 108.8 | 4.0 | 405 |
| Embodiment 7 | | | | | | | | | | |
| Comparative | 150.6 | 129.5 | 128.8 | 32.5 | 31.8 | 3.5 | 3.4 | 111.5 | 3.8 | 409 |
| Embodiment 8 | | | | | | | | | | |
| Comparative | 125.0 | 162.4 | 135.9 | 112.0 | 89.5 | 2.5 | 2.6 | 124.6 | 2.5 | 500 |
| Embodiment 9 | | | | | | | | | | |

The test results in Table 1 show that, by controlling the amount and type of the crosslinking agent and the polar polymer introduced, aramid films of high elongation-at-break and high toughness can be obtained. The elongation-at-break of the aramid films is at least 80.1%, the mechanical strength of the aramid films is at least 150.2 MPa, and the thermal stability is slightly reduced but remains at 410° C. or above. In addition, the withstand voltage can reach 150.8 kV/mm or above, and the hygroscopicity is less than or equal to 3.9%, thereby meeting the application requirements of electrical-grade insulation films. The data in Table 1 also shows that the aramid films of Embodiments 14 to 26 are significantly improved in terms of mechanical strength, elongation-at-break, and thermal stability compared with the aramid films prepared using a single crosslinking manner in Comparative Embodiments 7 to 8, indicating that the two crosslinking manners used in combination can more effectively improve the overall performance of the aramid films. Compared with commercial PI films, the aramid films prepared in this application exhibit higher mechanical strength and higher withstand voltage. The aramid films can be directly laminated with aramid paper without using an adhesive, and can be tightly bonded to the aramid paper directly, thereby facilitating use in the field of electrical insulation.

Understandably, this application is not limited to the embodiments described above and shown in the drawings, to which various modifications and changes may be made without departing from the scope hereof. The protection scope of this application is subject to the claims appended hereto.

What is claimed is:

1. A modified aramid dope, wherein the modified aramid dope is obtained by covalently and non-covalently crosslinking an aramid polymer, and the modified aramid dope comprises a polymer represented by Structural Formula 1: 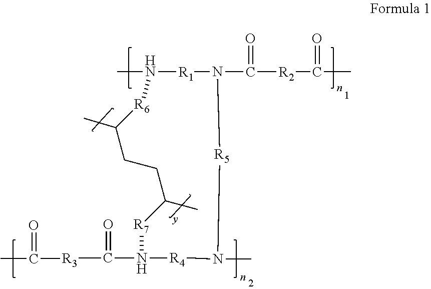
wherein in the formula above, 100≤n₁≤200; 100≤n₂≤200; y is a number-average molecular weight that ranges from 2000 to 4000;
R₁, R₂, R₃, and R₄ each independently are one of or 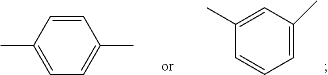
R₅ is one of 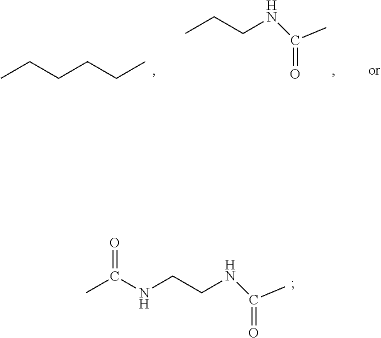
R₆ and R₇ each independently are one of —COOH, —CONH₂, or —OH;
a mass percent of the polymer in the modified aramid dope is 7% to 30%, and the remainder is a solvent; and
the aramid polymer is derived from a polymerization reaction between phthaloyl chloride and phenylenediamine.

2. The modified aramid dope according to claim 1, wherein the solvent is one of N,N-dimethylformamide, N,N-dimethylacetamide, dimethyl sulfoxide, or N-methylpyrrolidone.

3. The modified aramid dope according to claim 1, wherein the phthaloyl chloride is one of isophthaloyl chloride or terephthaloyl chloride.

4. The modified aramid dope according to claim 1, wherein the phenylenediamine is one of m-phenylenediamine or p-phenylenediamine.

5. A method for preparing the modified aramid dope according to claim 1, comprising the following steps:
step 1: preparing an aramid polymer dope: performing a polymerization reaction between phthaloyl chloride and phenylenediamine in a solvent under polymerization conditions to obtain a mixed polymer solution; adding a neutralization agent after completion of the reaction to neutralize an inorganic acid in the mixed polymer solution; and performing filtration to obtain the aramid polymer dope, wherein a mass concentration of the aramid polymer in the aramid polymer dope is 5% to 20%, a molar concentration of an aramid amide bond is 0.02 to 0.08 mol/g, a viscosity of the aramid polymer dope is 100 to 700 Pa·s, a molecular weight distribution is Mw/Mn=1.1 to 1.6, and a pH value of the aramid polymer dope is 7 to 8;
step 2: preparing a covalently crosslinked aramid dope: adding an organic base into the aramid polymer dope in step 1 to perform deprotonation, and then adding a crosslinking agent to perform a covalent crosslinking reaction to obtain the covalently crosslinked aramid dope, wherein a viscosity of the covalently crosslinked aramid dope is 210 to 750 Pa·s, and a pH value of the covalently crosslinked aramid dope is 7.5 to 8.5; and
step 3: preparing a modified aramid dope: adding a polar polymer into the covalently crosslinked aramid dope prepared in step 2, and stirring to form non-covalent crosslinks while protonating, so as to obtain the modified aramid dope, wherein a viscosity of the modified aramid dope is 240 to 800 Pa·s, and a pH value of the modified aramid dope is 7.0 to 7.5; and amide bonds that undergo covalent crosslinking and non-covalent crosslinking account for 5% to 20% of a total mass of amide bonds in the aramid polymer.

6. The method for preparing the modified aramid dope according to claim 5, wherein the organic base in step 2 is one of ethylamine, pyridine, or triethylamine.

7. The method for preparing the modified aramid dope according to claim 5, wherein the crosslinking agent in step 2 is an alkane containing a halogen element or an isocyanate group.

8. The method for preparing the modified aramid dope according to claim 5, wherein the polar polymer in step 3 is an alkyl-chain polymer.

9. An aramid film, wherein the aramid film is prepared by a biaxial stretching process from the modified aramid dope according to claim 1;
a thickness of the aramid film is 120.0 μm to 200.1 m;
a tensile strength of the aramid film is greater than or equal to 150.2 MPa;
an elongation-at-break of the aramid film is greater than or equal to 80.1%;
a heat resistance of the aramid film is greater than or equal to 410° C.;
dielectric strength of the aramid film is greater than or equal to 150.8 kV/mm; and
hygroscopicity of the aramid film is less than or equal to 3.9%.

10. A use of the aramid film according to claim 9, wherein the aramid film is directly laminated with aramid paper to prepare a composite material, an insulation class of the composite material is class F or class H.
